(19) United States
(12) Patent Application Publication
(10) Pub. No.: US 2016/0319087 A1
(43) Pub. Date: Nov. 3, 2016

(54) OIL FIELD APPARATUS

(71) Applicants: NISSIN KOGYO CO., LTD., Ueda-shi (JP); SCHLUMBERGER TECHNOLOGY CORPORATION, Sugar Land, TX (US); SHINSHU UNIVERSITY, Matsumoto-shi (JP)

(72) Inventors: Kenichi NIIHARA, Nagano (JP); Keiichi KAWAMOTO, Nagano (JP); Hiroyuki UEKI, Nagano (JP); Masaei ITO, Sagamihara-shi (JP); Toru NOGUCHI, Nagano (JP)

(73) Assignees: NISSIN KOGYO CO., LTD., Ueda-shi (JP); SCHLUMBERGER TECHNOLOGY CORPORATION, Sugar Land, TX (US); SHINSHU UNIVERSITY, Matsumoto-shi (JP)

(21) Appl. No.: 15/140,123

(22) Filed: Apr. 27, 2016

(30) Foreign Application Priority Data
Apr. 28, 2015 (JP) 2015-091385

(51) Int. Cl. C08J 5/00; C08J 5/04; E21B 4/00; F16J 15/3284; E21B 4/02; E21B 47/00

(52) U.S. Cl. CPC C08J 5/005; E21B 4/02; E21B 47/00; E21B 4/003; F16J 15/3284; C08J 5/045; E21B 7/04

(57) ABSTRACT

An oilfield apparatus includes a seal member. The seal member is formed of a rubber composition that includes a rubber, and at least either oxycellulose fibers or cellulose nanofibers that are dispersed in the rubber in an untangled state, and does not include an aggregate that includes at least either the oxycellulose fibers or the cellulose nanofibers and has a diameter of 0.1 mm or more. The rubber composition includes at least either the oxycellulose fibers or the cellulose nanofibers in a ratio of 1 to 60 parts by mass based on 100 parts by mass of the rubber. The oxycellulose fibers have an average fiber diameter of 10 to 30 micrometers. The cellulose nanofibers have an average fiber diameter of 1 to 200 nm.

Japanese Patent Application No. 2015-091385, filed on Apr. 28, 2015, is hereby incorporated by reference in its entirety.

### BACKGROUND OF THE INVENTION

The present invention relates to an oilfield apparatus that includes a seal member that includes at least either oxycellulose fibers or cellulose nanofibers.

In recent years, cellulose nanofibers obtained by untangling natural cellulose fibers so as to have a nanosize have attracted attention. Natural cellulose fibers are biomass produced using pulp (wood) as a raw material, and it is expected that the environmental load can be reduced by effectively utilizing natural cellulose fibers.

For example, a method for producing a rubber composition has been proposed that includes a step that mixes a rubber latex with an aqueous dispersion including cellulose fibers, and removes at least part of water from the mixture to obtain a cellulose fiber-rubber composite, and a step that mixes the composite with a rubber (see JP-A-2013-18918, for example).

However, since the cellulose fibers form a hydrogen bond and aggregate during the drying step that removes part of water from the mixture, the aggregates (masses) of the cellulose fibers remain in the rubber composition. Since the aggregates of the cellulose fibers form defects in the rubber composition, the rubber composition cannot be sufficiently reinforced by the cellulose fibers.

A seal material that utilizes a carbon fiber composite material is proposed in the field of oilfield apparatuses, and has been used all over the world (see JP-A-2013-14699, JP-A-2013-23575, WO2011/077598A1, WO2011/077596A1, WO2011/077595A1, and WO2009/125503A1, for example). Since carbon nanotubes used as a raw material for producing the carbon fiber composite material are relatively expensive, it has been desired to produce the carbon nanotubes at low cost through mass production. However, technology that can meet this demand has not been developed yet.

### SUMMARY

One aspect of the invention may provide an oilfield apparatus that includes a seal member that includes at least either oxycellulose fibers or cellulose nanofibers.

According to one aspect of the invention, there is provided an oilfield apparatus including a seal member that is formed of a rubber composition that includes a rubber, and at least either oxycellulose fibers or cellulose nanofibers that are dispersed in the rubber in an untangled state, and does not include an aggregate that includes at least either the oxycellulose fibers or the cellulose nanofibers and has a diameter of 0.1 mm or more,

the rubber composition including at least either the oxycellulose fibers or the cellulose nanofibers in a ratio of 1 to 60 parts by mass based on 100 parts by mass of the rubber,

the oxycellulose fibers having an average fiber diameter of 10 to 30 micrometers, and

the cellulose nanofibers having an average fiber diameter of 1 to 200 nm.

### BRIEF DESCRIPTION OF THE SEVERAL VIEWS OF THE DRAWING

FIG. 1 is a schematic view illustrating a dispersion step included in a method for producing a rubber composition.

FIG. 2 is a schematic view illustrating a dispersion step included in a method for producing a rubber composition.

FIG. 3 is a schematic view illustrating a dispersion step included in a method for producing a rubber composition.

FIG. 4 is a schematic view illustrating a downhole apparatus during use.

FIG. 5 is a schematic view illustrating part of a downhole apparatus.

FIG. 6 is a vertical cross-sectional view illustrating a pressure vessel connection part of a downhole apparatus.

FIG. 7 is a vertical cross-sectional view illustrating another method for using an O-ring used for a downhole apparatus.

FIG. 8 is a vertical cross-sectional view illustrating another method for using an O-ring used for a downhole apparatus.

FIG. 9 is a cross-sectional view schematically illustrating a logging tool that is used for subsea applications.

FIG. 10 is a partial cross-sectional view schematically illustrating the logging tool illustrated in FIG. 9.

FIG. 11 is an X-X′ cross-sectional view schematically illustrating a mud motor of the logging tool illustrated in FIG. 10.

FIG. 12 is a cross-sectional view schematically illustrating a logging tool that is used for underground applications.

FIG. 13 illustrates an optical micrograph of the rubber composition of Comparative Example 1.

FIG. 14 illustrates an optical micrograph of the rubber composition of Comparative Example 2.

FIG. 15 illustrates an optical micrograph of the rubber composition of Example 1.

FIG. 16 illustrates an optical micrograph of the rubber composition of Example 4.

FIG. 17 illustrates an optical micrograph of the rubber composition of Example 7.

### DETAILED DESCRIPTION OF THE EMBODIMENT

According to one embodiment of the invention, an oilfield apparatus includes a seal member that is formed of a rubber composition that includes a rubber, and at least either oxycellulose fibers or cellulose nanofibers that are dispersed in the rubber in an untangled state, and does not include an aggregate that includes at least either the oxycellulose fibers or the cellulose nanofibers and has a diameter of 0.1 mm or more,

the rubber composition including at least either the oxycellulose fibers or the cellulose nanofibers in a ratio of 1 to 60 parts by mass based on 100 parts by mass of the rubber,

the oxycellulose fibers having an average fiber diameter of 10 to 30 micrometers, and

the cellulose nanofibers having an average fiber diameter of 1 to 200 nm.

The oilfield apparatus includes the seal member that is formed of the rubber composition that is reinforced by at least either the oxycellulose fibers or the cellulose nanofibers, and exhibits excellent volume resistivity, rigidity, strength, and fatigue resistance. Specifically, the oilfield apparatus includes the seal member that is competitive in price with respect to a seal member that utilizes carbon nanotubes.

In the oilfield apparatus, the seal member may be an endless seal member that is disposed in the oilfield apparatus.

The oilfield apparatus may be a logging tool that performs a logging operation in a borehole.

In the oilfield apparatus, the seal member may be a stator of a fluid-driven motor that is disposed in the oilfield apparatus.

In the oilfield apparatus, the seal member may be a rotor of a fluid-driven motor that is disposed in the oilfield apparatus.

In the oilfield apparatus, the fluid-driven motor may be a mud motor.

In the oilfield apparatus, the rubber may be a hydrogenated acrylonitrile-butadiene rubber (H-NBR), and the rubber composition may have a volume resistivity of 10⁸ to 10¹⁰ ohm-cm.

In the oilfield apparatus, the rubber composition may have a number of cycles to fracture of 3,000 or more when subjected to a tension fatigue test at a temperature of 120° C., a maximum tensile stress of 1 N/mm, and a frequency of 1 Hz.

In the oilfield apparatus, the rubber composition may have an elongation at break of 330% or more.

The exemplary embodiments of the invention are described in detail below with reference to the drawings.

A raw material for producing the seal member used for the oilfield apparatus, a method for producing the rubber composition used to produce the seal member, the rubber composition, the seal member, and the oilfield apparatus are described below in this order.

### A. Raw Material for Producing Seal Member

### A-1. Aqueous Solution

An aqueous solution used as a raw material for producing the seal member may be an aqueous solution that includes the oxycellulose fibers, an aqueous solution that includes the cellulose nanofibers, or an aqueous solution that includes the oxycellulose fibers and the cellulose nano fibers.

The aqueous solution that includes the oxycellulose fibers may be produced by performing an oxidation step that oxidizes natural cellulose fibers to obtain oxycellulose fibers, for example.

The aqueous solution that includes the cellulose nanofibers may be produced using a production method that includes an oxidation step that oxidizes natural cellulose fibers to obtain oxycellulose fibers, and a miniaturization step that miniaturizes the oxycellulose fibers, for example.

The aqueous solution that includes the oxycellulose fibers and the cellulose nanofibers may be obtained by mixing an aqueous solution that includes the oxycellulose fibers and an aqueous solution that includes the cellulose nanofibers.

In the oxidation step, water is added to natural cellulose fibers (raw material), and the mixture is processed using a mixer or the like to prepare a slurry in which the natural cellulose fibers are dispersed in water.

Examples of the natural cellulose fibers include wood pulp, cotton-based pulp, bacterial cellulose, and the like. Examples of the wood pulp include conifer-based pulp, broadleaf tree-based pulp, and the like. Examples of the cotton-based pulp include cotton linter, cotton lint, and the like. Examples of non-wood pulp include straw pulp, bagasse pulp, and the like. These natural cellulose fibers may be used either alone or in combination.

Natural cellulose fibers have a structure in which the space between cellulose microfibril bundles is filled with lignin and hemicellulose. Specifically, it is considered that natural cellulose fibers have a structure in which cellulose microfibrils and/or cellulose microfibril bundles are covered with hemicellulose, and the hemicellulose is covered with lignin. The cellulose microfibrils and/or the cellulose microfibril bundles are strongly bonded by lignin to form plant fibers. Therefore, it is preferable that lignin be removed from the plant fibers in advance in order to prevent the aggregation of the cellulose fibers included in the plant fibers. The lignin content in the plant fiber-containing material is normally about 40 mass % or less, and preferably about 10 mass % or less. The lower limit of the lignin removal ratio is not particularly limited. It is preferable that the lignin removal ratio be as close to 0 mass % as possible. Note that the lignin content may be measured using the Klason method.

The minimum unit of cellulose microfibrils has a width of about 4 nm, and may be referred to as “single cellulose nanofiber”. The term “cellulose nanofiber” used herein refers to a cellulose fiber obtained by untangling natural cellulose fibers and/or oxycellulose fibers to have a nanosize. The cellulose nanofibers may have an average fiber diameter of 1 to 200 nm, or may have an average fiber diameter of 1 to 150 nm. In particular, the cellulose nanofibers may be cellulose microfibrils and/or cellulose microfibril bundles having an average fiber diameter of 1 to 100 nm. Specifically, the cellulose nanofibers may include single cellulose nanofibers, or bundles of a plurality of single cellulose nanofibers.

The average aspect ratio (fiber length/fiber diameter) of the cellulose nanofibers may be 10 to 1,000, or may be 10 to 500, or may be 100 to 350.

Note that the average fiber diameter and the average fiber length of the cellulose nanofibers refer to the arithmetic mean values calculated from the values measured with respect to at least fifty cellulose nanofibers within the field of view of an electron microscope.

In the oxidation step, the natural cellulose fibers are oxidized in water using an N-oxyl compound as an oxidizing catalyst to obtain oxycellulose fibers. Examples of the N-oxyl compound that may be used as the cellulose oxidizing catalyst include 2,2,6,6-tetramethyl-1-piperidine-N-oxyl (hereinafter may be referred to as “TEMPO”), 4-acetamide-TEMPO, 4-carboxy-TEMPO, 4-phosphonooxy-TEMPO, and the like.

A purification step that repeats washing with water and filtration, for example, may be performed after the oxidation step to remove impurities (e.g., unreacted oxidizing agent and by-products) from the slurry that includes the oxycellulose fibers. The solution that includes the oxycellulose fibers is in a state in which the oxycellulose fibers are impregnated with water, for example. Specifically, the oxycellulose fibers have not been untangled to cellulose nanofiber units. Water may be used as the solvent. Note that a water-soluble organic solvent (e.g., alcohol, ether, or ketone) may also be used taking account of the object.

The oxycellulose fibers include a carboxyl group since some of the hydroxyl groups have been modified with a substituent that includes a carboxyl group.

The oxycellulose fibers have an average fiber diameter of 10 to 30 micrometers. Note that the average fiber diameter of the oxycellulose fibers refer to the arithmetic mean value calculated from the values measured with respect to at least fifty oxycellulose fibers within the field of view of an electron microscope.

The oxycellulose fibers may be cellulose microfibril bundles. The oxycellulose fibers need not necessarily be untangled to cellulose nanofiber units in the mixing step and the drying step (described later). The oxycellulose fibers may be untangled to cellulose nanofibers in the miniaturization step.

In the miniaturization step, the oxycellulose fibers may be stirred in a solvent (e.g., water) to obtain cellulose nanofibers.

In the miniaturization step, water may be used as the solvent (dispersion medium). A water-soluble organic solvent (e.g., alcohol, ether, or ketone) may also be used either alone or in combination.

In the miniaturization step, the oxycellulose fibers may be stirred using a disintegrator, a refiner, a low-pressure homogenizer, a high-pressure homogenizer, a grinder, a cutter mill, a ball mill, a jet mill, a single-screw extruder, a twin-screw extruder, an ultrasonic stirrer, a domestic juicer mixer (juicing mixer), or the like.

In the miniaturization step, the solid content in the solution (solvent) that includes the oxycellulose fibers may be 50 mass % or less, for example. If the solid content exceeds 50 mass %, high energy may be required to implement dispersion.

The aqueous solution that includes the cellulose nanofibers can be obtained by the miniaturization step. The aqueous solution that includes the cellulose nanofibers may be a colorless transparent suspension or a translucent suspension. The suspension has a configuration in which the cellulose nanofibers (i.e., fibers that have been surface-oxidized and untangled (miniaturized)) are dispersed in water. Specifically, the cellulose nanofibers are obtained by reducing the strong cohesive force (hydrogen bonds) between the microfibrils by introducing carboxyl groups in the oxidation step, and further performing the miniaturization step. The carboxyl group content, the polarity, the average fiber diameter, the average fiber length, the average aspect ratio, and the like can be controlled by adjusting the oxidation conditions.

The aqueous solution thus obtained may include the cellulose nanofibers in a ratio of 0.1 to 10 mass %. The aqueous solution may be diluted so that the cellulose nanofiber content is 1 mass %, for example. The aqueous solution may have a light transmittance of 40% or more, or 60% or more, or 80% or more. The transmittance of the aqueous solution may be measured using a UV spectrophotometer as the transmittance at a wavelength of 660 nm.

### A-2. Rubber Latex

A natural rubber latex solution or a synthetic rubber latex solution may be used as a rubber latex.

A natural rubber/water-based solution that is a natural product due to the metabolic action of plants, and includes water as a dispersion solvent, may be used as the natural rubber latex solution. The synthetic rubber latex solution may be obtained by producing a styrene-butadiene-based rubber, a butadiene rubber, a methyl methacrylate-butadiene-based rubber, a 2-vinylpyridine-styrene-butadiene-based rubber, an acrylonitrile-butadiene-based rubber, a chloroprene rubber, a silicone rubber, a fluororubber, or the like by emulsion polymerization.

The rubber latex has a configuration in which a large number of rubber microparticles are dispersed in a dispersion solvent.

The rubber may be a hydrogenated acrylonitrile-butadiene rubber (H-NBR). A hydrogenated acrylonitrile-butadiene rubber may be referred to as a hydrogenated nitrile rubber, hydrogenated acrylonitrile-butadiene rubber, or the like. A hydrogenated acrylonitrile-butadiene rubber is hereinafter referred to as “H-NBR”. H-NBR may be obtained by hydrogenating a double bond included in a nitrile rubber (NBR). Since H-NBR exhibits relatively excellent high-temperature properties and excellent abrasion resistance, H-NBR may be used as a material for producing a seal member used for a logging tool, for example. H-NBR can also be used at a high temperature of less than 175° C., and may suitably be used at a temperature up to 150° C. H-NBR used in connection with one embodiment of the invention may have an acrylonitrile content of 30 to 50 mass %, a Mooney viscosity (ML₁₊₄100° C.) center value of 50 to 100, and a hydrogenation rate of 90% or more. When the acrylonitrile content is 30 mass % or more, H-NBR exhibits excellent oil resistance, and rarely shows blistering due to high gas permeation. When the acrylonitrile content is 50 mass % or less, H-NBR exhibits water resistance, and may be used in an aqueous system. When the Mooney viscosity (ML₁₊₄100° C.) center value is 50 or more, H-NBR satisfies the basic requirements (e.g., tensile strength (TB) and permanent set (PS)). When the Mooney viscosity (ML₁₊₄100° C.) center value is 100 or less, H-NBR has a moderate viscosity that allows H-NBR to be processed. When the hydrogenation rate is 90% or more, H-NBR exhibits excellent heat resistance.

### B. Method for Producing Seal Member

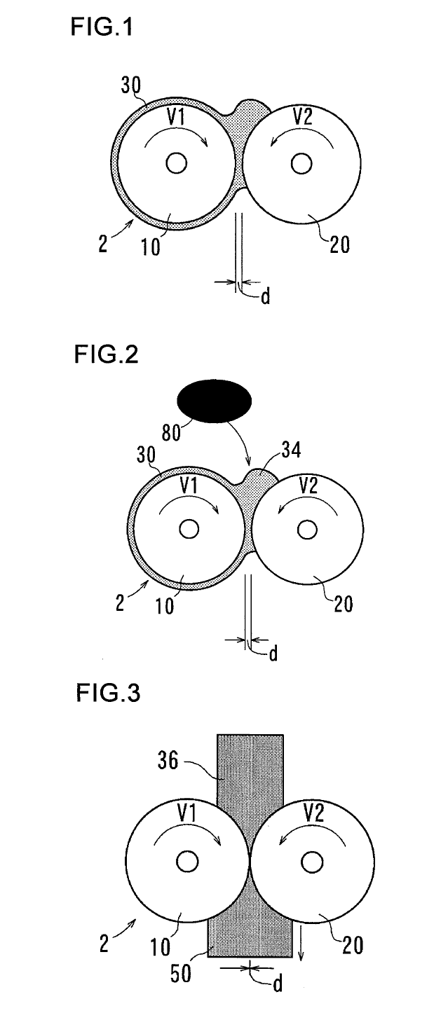

FIGS. 1 to 3 are schematic views illustrating a method for producing the rubber composition used to produce the seal member.

The method for producing the rubber composition includes a mixing step that mixes an aqueous solution that includes at least either oxycellulose fibers or cellulose nanofibers with a rubber latex to obtain a first mixture, a drying step that dries the first mixture to obtain a second mixture, and a dispersion step that tight-mills the second mixture using an open roll to obtain a rubber composition.

### B-1. Mixing Step

In the mixing step, an aqueous solution that includes at least either oxycellulose fibers or cellulose nanofibers is mixed with a rubber latex to obtain the first mixture. The mixing step may be implemented using a roll mixing method that utilizes a roll mixer, a stirring operation that utilizes a propeller stirrer, a homogenizer, a rotary stirrer, or an electromagnetic stirrer, a manual stirring operation, or the like. In particular, the mixing step may be implemented using the roll mixing method.

An open roll (open roll mill) may be used as the roll mixer used for the roll mixing method, for example. A double roll mill or a triple roll mill may be used as the roll mixer used for the roll mixing method, for example.

The mixture of the aqueous solution and the rubber latex is gradually supplied to the roll mixer in which the roll distance is set to a predetermined distance. The roll distance may be set so that the mixture of the aqueous solution and the rubber latex is wound around the rolls, but does not fall through the space between the rolls. The viscosity of the mixture supplied to the roll mixer gradually increases due to mixing. When the viscosity of the mixture has increased, the mixture may be removed from the roll mixer, and supplied to the roll mixer again after reducing the roll distance. This step may be repeated a plurality of times.

It is considered that at least either the oxycellulose fibers or the cellulose nanofibers enter the space between the rubber microparticles during the mixing step while the mixture passes through the space between the rolls. In particular, the reinforcing effect due to the fibers can be improved by utilizing the roll mixing method as compared with the case of using another stirring operation.

The first mixture obtained by the mixing step may include at least either the oxycellulose fibers or the cellulose nanofibers in a ratio of 1 to 60 parts by mass based on 100 parts by mass of the rubber (on a solid basis) (mass ratio after the drying step). The reinforcing effect can be obtained when the first mixture includes at least either the oxycellulose fibers or the cellulose nanofibers in a ratio of 1 part by mass or more. When the first mixture includes at least either the oxycellulose fibers or the cellulose nanofibers in a ratio of 60 parts by mass or less, it is possible to process the mixture after the drying step.

### B-2. Drying Step

In the drying step, the first mixture obtained by the mixing step is dried to obtain the second mixture. For example, the drying step may be implemented using a normal method that removes water since the first mixture includes water. For example, the drying step may be implemented using a known drying method such as an air-drying method, an oven drying method, a freeze-drying method, a spray drying method, or a pulse combustion method.

The drying step may be performed at a temperature at which the rubber, the oxycellulose fibers, and the cellulose nanofibers are not thermally decomposed. For example, the first mixture may be dried by heating the first mixture at 100° C.

The second mixture includes the rubber component, and at least either the oxycellulose fibers or the cellulose nanofibers. For example, the second mixture may include at least either the oxycellulose fibers or the cellulose nanofibers in a ratio of 1 to 60 parts by mass based on 100 parts by mass of the rubber. The second mixture may include at least either the oxycellulose fibers or the cellulose nanofibers in a ratio of 1 to 50 parts by mass. In particular, the second mixture may include at least either the oxycellulose fibers or the cellulose nanofibers in a ratio of 5 to 40 parts by mass. The rubber composition can be reinforced when the second mixture includes at least either the oxycellulose fibers or the cellulose nanofibers in a ratio of 1 part by mass or more. It is possible to easily process the mixture when the second mixture includes at least either the oxycellulose fibers or the cellulose nanofibers in a ratio of 60 parts by mass or less.

### B-3. Dispersion Step

In the dispersion step, the second mixture that includes at least either the oxycellulose fibers or the cellulose nanofibers is tight-milled using the open roll to obtain the rubber composition.

As illustrated in FIG. 1, a second mixture 30 that is wound around a first roll 10 may be masticated before tight-milling the second mixture. The molecular chains of the rubber included in the second mixture are moderately cut by mastication to produce free radicals. The free radicals of the rubber produced by mastication easily bond to at least either the oxycellulose fibers or the cellulose nanofibers.

As illustrated in FIG. 2, a compounding ingredient 80 may be appropriately supplied to a bank 34 of the second mixture 30 that is wound around the first roll 10, and the mixture may be mixed to obtain an intermediate mixture (mixing step). Examples of the compounding ingredient 80 include a cross-linking agent, a vulcanizing agent, a vulcanization accelerator, a vulcanization retarder, a softener, a plasticizer, a curing agent, a reinforcing agent, a filler, an aging preventive, a colorant, an acid acceptor, and the like. These compounding ingredients may be added to the rubber at an appropriate timing during the mixing process.

The intermediate mixture 36 illustrated in FIGS. 1 and 2 may be obtained using an internal mixing method, a multi-screw extrusion kneading method, or the like instead of the open-roll method.

As shown in FIG. 3, the intermediate mixture 36 may be tight-milled. The intermediate mixture 36 may be tight-milled at 0 to 50° C. using an open roll 2 that is set at a roll distance of 0.5 mm or less to obtain an uncrosslinked rubber composition 50 (tight-milling step). In the tight-milling step, the distance d between the first roll 10 and a second roll 20 is set to 0.5 mm or less, and preferably 0 to 0.5 mm, for example. The intermediate mixture 36 obtained as illustrated in FIG. 2 is supplied to the open roll 2, and tight-milled one or more times. The intermediate mixture 36 may be tight-milled about once to ten times, for example. When the surface velocity of the first roll 10 is referred to as V1, and the surface velocity of the second roll 20 is referred to as V2, the surface velocity ratio (V1/V2) of the first roll 10 to the second roll 20 during tight-milling may be 1.05 to 3.00, and preferably 1.05 to 1.2. The desired shear force can be applied by utilizing such a surface velocity ratio.

The rubber composition 50 that is extruded through the narrow space between the rolls is deformed to a large extent due to a restoring force achieved by the elasticity of the rubber (see FIG. 3), and at least either the oxycellulose fibers or the cellulose nanofibers move to a large extent together with the rubber. The rubber composition 50 obtained by tight-milling is rolled (sheeted) by the rolls to have a predetermined thickness (e.g., 100 to 500 micrometers).

The tight-milling step may be performed while setting the roll temperature to 0 to 50° C. (or a relatively low temperature of 5 to 30° C.) in order to obtain as high a shear force as possible, for example. In this case, the measured temperature of the rubber composition is also adjusted to 0 to 50° C. (or 5 to 30° C.).

When the roll temperature is adjusted to a value within the above range, it is possible to untangle at least either the oxycellulose fibers or the cellulose nanofibers by utilizing the elasticity of the rubber, and disperse the untangled fibers in the rubber composition.

A high shear force is applied to the rubber during the tight-milling step, and at least either the oxycellulose fibers or the cellulose nanofibers that have aggregated are separated and removed one by one by the molecules of the rubber, and become dispersed in the rubber. In particular, since the rubber has elasticity and viscosity, at least either the oxycellulose fibers or the cellulose nanofibers can be untangled, and dispersed. The rubber composition 50 in which at least either the oxycellulose fibers or the cellulose nanofibers exhibit excellent dispersibility and dispersion stability (i.e., at least either the oxycellulose fibers or the cellulose nanofibers rarely reaggregate) can thus be obtained.

More specifically, when the rubber and at least either the oxycellulose fibers or the cellulose nanofibers are mixed using the open roll, the viscous rubber enters the space between at least either the oxycellulose fibers or the cellulose nanofibers. When the surface of at least either the oxycellulose fibers or the cellulose nanofibers have been moderately activated by an oxidation treatment, for example, at least either the oxycellulose fibers or the cellulose nanofibers are easily bonded to the molecules of the rubber. When a high shear force is then applied to the rubber, at least either the oxycellulose fibers or the cellulose nanofibers move along with the movement of the molecules of the rubber. At least either the oxycellulose fibers or the cellulose nanofibers that have aggregated are separated by the restoring force of the rubber due to elasticity after shearing, and become dispersed in the rubber. It is preferable to use the open-roll method since the actual temperature of the mixture can be measured and controlled while controlling the roll temperature.

### B-4. Coagulation Step

The method for producing the rubber composition may further include a coagulation step between the mixing step and the drying step, the coagulation step coagulating the rubber latex included in the first mixture.

Since the first mixture obtained by the mixing step (see B-1) includes a large amount of water, it takes time to remove water in the drying step (see B-2). In the coagulation step, a specific amount of a known coagulant that coagulates rubber latex is added to the first mixture (aqueous solution), and the mixture is stirred (mixed). The rubber component included in the first mixture is thus coagulated by the coagulant. In the coagulation step, the coagulate may then be dehydrated and washed. The coagulate may be repeatedly dehydrated and washed a plurality of times.

It suffices that the coagulate be dehydrated so that water can be removed to such an extent that the drying time in the drying step can be reduced. The coagulated rubber component and water are separated to a certain extent by dehydrating the coagulate. The coagulate may be dehydrated using a rotary dehydrator (centrifuge), a rubber-covered roll, a press, or the like. The coagulate may be washed using water, for example.

A known latex coagulant may be appropriately selected as the coagulant taking account of the type of the rubber latex included in the first mixture. For example, a known acid or salt may be used as the coagulant. A polymer coagulant may be used instead of (or in addition to) a salt. Examples of the acid that may be used as the coagulant include formic acid, acetic acid, propionic acid, citric acid, oxalic acid, sulfuric acid, hydrochloric acid, carbonic acid, and the like. Examples of the salt that may be used as the coagulant include sodium chloride, aluminum sulfate, calcium nitrate, and the like. An anionic polymer coagulant, a cationic polymer coagulant, or a nonionic polymer coagulant may be used as the polymer coagulant.

Since a large amount of water can be removed from the first mixture by performing the coagulation step, it is possible to reduce the heating time in the drying step performed after the coagulation step, and improve the work efficiency.

### C. Rubber Composition

The rubber composition is obtained using the method for producing the rubber composition, and includes at least either oxycellulose fibers or cellulose nanofibers that are dispersed therein in an untangled state.

The rubber composition includes a rubber, and at least either oxycellulose fibers or cellulose nanofibers that are dispersed in the rubber in an untangled state, and does not include an aggregate that includes at least either the oxycellulose fibers or the cellulose nano fibers, and has a diameter of 0.1 mm or more.

An aggregate that includes at least either the oxycellulose fibers or the cellulose nanofibers is a mass of these fibers, and may be an aggregate of the oxycellulose fibers, an aggregate of the cellulose nanofibers, or an aggregate of the oxycellulose fibers and the cellulose nanofibers.

The rubber composition according to one embodiment of the invention does not include an aggregate, is reinforced by at least either the oxycellulose fibers or the cellulose nanofibers that are dispersed therein in an untangled state, and exhibits excellent rigidity, strength, and fatigue resistance.

The rubber composition may include at least either the oxycellulose fibers or the cellulose nanofibers in a ratio of 1 to 60 parts by mass based on 100 parts by mass of the rubber.

A compounding ingredient that is normally used when processing rubber may be added to the rubber composition. A known compounding ingredient may be used as the compounding ingredient. Examples of the compounding ingredient include a cross-linking agent, a vulcanizing agent, a softener, a plasticizer, a reinforcing agent, a filler, a colorant, and the like. These compounding ingredients may be added to the rubber at an appropriate timing during the mixing process.

The rubber composition has high insulation performance (insulating properties). For example, the rubber composition may have a volume resistivity of 10⁸ ohm-cm or more. When the rubber is a hydrogenated acrylonitrile-butadiene rubber (H-NBR), the rubber composition may have a volume resistivity of 10⁸ to 10¹⁰ ohm-cm, or may have a volume resistivity of 1.1×10⁸ to 10¹⁰ ohm-cm. Such a rubber composition can be used to produce a seal member that is provided to an oilfield apparatus and required to exhibit insulating properties in order to protect an electronic part and the like provided to the oilfield apparatus.

The rubber composition also has high anti-wear performance at a high temperature. For example, the rubber composition may have a number of cycles to fracture of 3,000 or more when subjected to a tension fatigue test at a temperature of 120° C., a maximum tensile stress of 1 N/mm, and a frequency of 1 Hz. When the rubber is a hydrogenated acrylonitrile-butadiene rubber (H-NBR), the rubber composition may have a number of cycles to fracture of 3,000 or more when subjected to a tension fatigue test at a temperature of 120° C., a maximum tensile stress of 1 N/mm, and a frequency of 1 Hz, or may have a number of cycles to fracture of 3,300 or more when subjected to a tension fatigue test at a temperature of 120° C., a maximum tensile stress of 1 N/mm, and a frequency of 1 Hz.

The rubber composition can maintain high flexibility even when reinforced by at least either the oxycellulose fibers or the cellulose nanofibers. For example, the rubber composition may have an elongation at break of 330% or more. When the rubber is a hydrogenated acrylonitrile-butadiene rubber (H-NBR), the rubber composition may have an elongation at break of 330% or more, or may have an elongation at break of 340% or more.

### D. Seal Member

The seal member is formed of the rubber composition described above (see “C. Rubber composition”). The seal member is obtained by forming the rubber composition to have the desired shape. When forming the rubber composition, the rubber included in the rubber composition may be cross-linked using a cross-linking agent.

The cross-linking agent may be mixed (added) before mixing the rubber with at least either the oxycellulose fibers or the cellulose nanofibers, or may be mixed (added) when mixing the rubber with at least either the oxycellulose fibers or the cellulose nanofibers, or may be mixed with (added to) the rubber composition that has been tight-milled and sheeted. A cross-linked rubber composition can be obtained by cross-linking the rubber component included in the rubber composition to which the cross-linking agent has been added. A known cross-linking agent that is applied to a rubber may be appropriately selected taking account of the application, for example.

The seal member may be obtained by molding the rubber composition to have the desired shape (e.g., endless shape) using an ordinary rubber molding method (e.g., injection molding, transfer molding, press molding, extrusion molding, or calendering). The seal member may be formed of the cross-linked rubber composition.

The seal member may be used as a gasket used for a stationary part included in the oilfield apparatus, or may be used as a gasket used for a moving part included in the oilfield apparatus. For example, the seal member may be an endless seal member disposed in the oilfield apparatus. The endless seal member has an external shape without ends. The external shape of the endless seal member may be circular or polygonal corresponding to the shape of a groove or a member in which the seal member is disposed, for example. The endless seal member may be an O-ring having a circular horizontal cross-sectional shape. The endless seal member may be a D-ring, an X-ring, or a lip ring (e.g., U-lip ring and V-lip ring), for example.

The seal member may be a stator of a fluid-driven motor that is disposed in the oilfield apparatus. The seal member may be a rotor of a fluid-driven motor that is disposed in the oilfield apparatus. The seal member used for the oilfield apparatus is described in detail below.

### E. Oilfield Applications

The seal member may be used for the oilfield apparatus (i.e., oilfield applications), for example. Typical embodiments of the oilfield apparatus are described below.

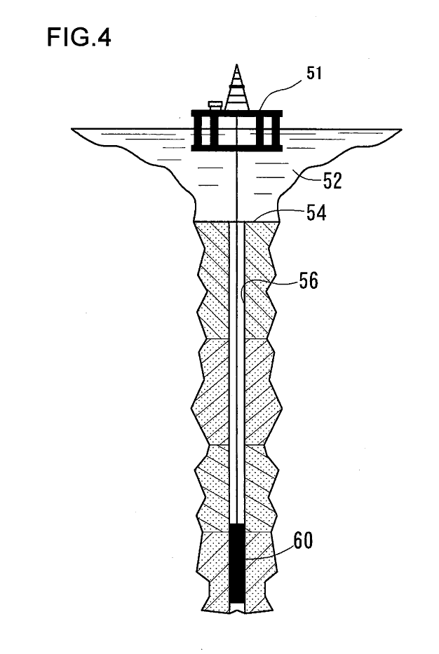

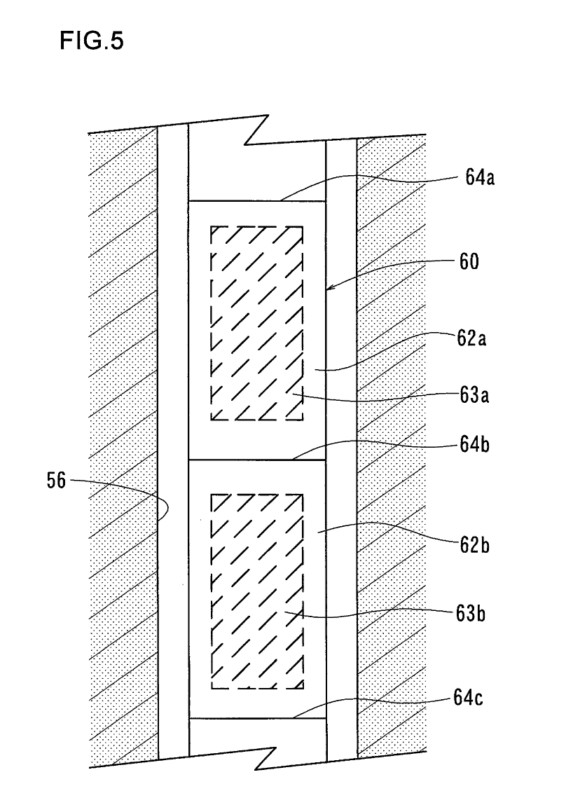

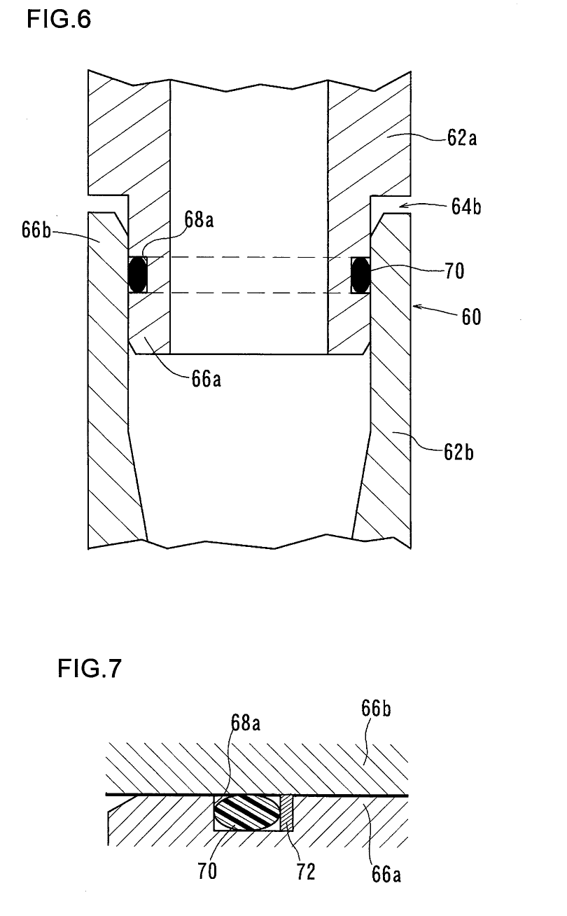

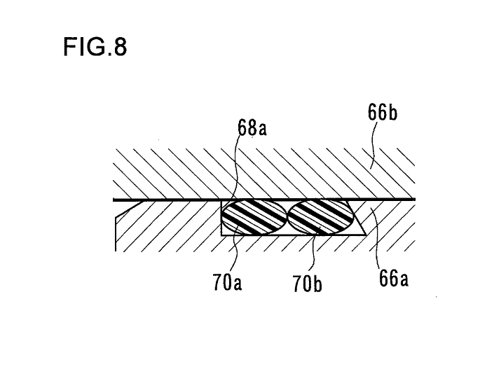

FIG. 4 is a schematic view illustrating a downhole apparatus during use. FIG. 5 is a schematic view illustrating part of the downhole apparatus. FIG. 6 is a vertical cross-sectional view illustrating a pressure vessel connection part of the downhole apparatus. FIG. 7 is a vertical cross-sectional view illustrating still another method for using an O-ring for the downhole apparatus. FIG. 8 is a vertical cross-sectional view illustrating another method for using an O-ring for the downhole apparatus.

As shown in FIG. 4, when searching for underground resources, a downhole apparatus 60 is caused to advance in a well 56 (vertical or horizontal passageway) formed in an ocean floor 54 from a platform 51 on the sea 52, and the underground structure and the like are probed to determine the presence or absence of the target substance (e.g., petroleum), for example. The downhole apparatus 60 is secured on the end of a long rod extending from the platform, for example. The downhole apparatus 60 includes a plurality of pressure vessels 62a and 62b illustrated in FIG. 5, and may also include a drill bit (not shown) at the end. The adjacent pressure vessels 62a and 62b are liquid-tightly connected through connection parts 64a, 64b, and 64c on either end. Electronic instruments 63a and 63b (e.g., sonic logging system) are respectively enclosed in the pressure vessels 62a and 62b so that the underground structure and the like can be probed.

As illustrated in FIG. 6, an end 66a of the pressure vessel 62a has a cylindrical shape having an outer diameter smaller to some extent than the inner diameter of an end 66b of the pressure vessel 62b. An endless seal member (see “D. Seal member”) (e.g., O-ring 70) is provided in a groove 68a formed in the outer circumferential surface of the end 66a. The O-ring 70 is a circular endless seal member that is formed using the seal member and having an external shape without ends. The O-ring 70 has a circular horizontal cross-sectional shape. The connection part 64b between the pressure vessels 62a and 62b is liquid-tightly sealed by inserting the end 66a of the pressure vessel 62a into the end 66b of the pressure vessel 62b so that the O-ring 70 is flatly deformed. Since the downhole apparatus 60 is operated in the well 56 formed deep in the ground, it is necessary to liquid-tightly keep the pressure vessels 62a and 62b at a high temperature under high pressure. The O-ring 70 used for the downhole apparatus 60 according to one embodiment of the invention is characterized in that the elastomer deteriorates to only a small extent at a high temperature. Moreover, the O-ring 70 can maintain excellent flexibility and strength even at a high temperature.

As illustrated in FIG. 7, a resin back-up ring 72 may be provided in the groove 68a in addition to the O-ring 70, for example. As illustrated in FIG. 8, two O-rings 70a and 70b may be provided in the groove 68a to improve the seal performance, for example.

For example, the seal member may be used as a dynamic seal member used for a logging tool, a rotating machine (e.g., motor), a reciprocating machine (e.g., piston), or the like. The logging tool records physical properties of a formation, a reservoir, and the like inside and around a borehole, geometrical properties (e.g., pore size, orientation, and slope) of a borehole or a casing, the flow behavior of a reservoir, and the like at each depth. For example, the logging tool may be used in an oilfield.

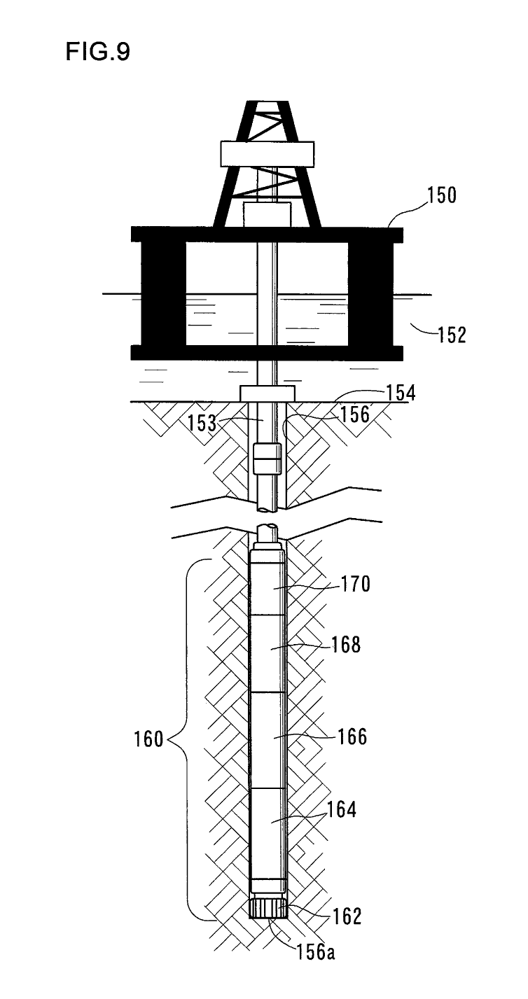

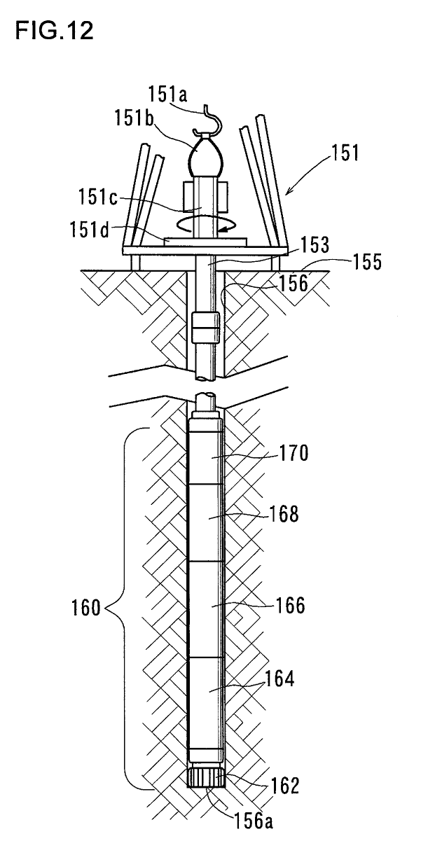

For example, the logging tool may be used for subsea applications illustrated in FIG. 9 or underground applications illustrated in FIG. 12. The logging tool is classified as a wireline log/logging tool, a mud logging tool, a logging-while-drilling (LWD) tool, a measurement-while-drilling (MWD) tool (i.e., a measuring instrument is provided in a drilling assembly), and the like. Since these logging tools are used at a deep underground position, the dynamic seal member is subjected to a severe environment. It may be necessary for the seal member to endure friction at a high temperature (particularly 175° C. or more) to maintain liquid-tightness. Therefore, the dynamic seal member may be required to exhibit heat resistance higher than that required for an H-NBR composite material.

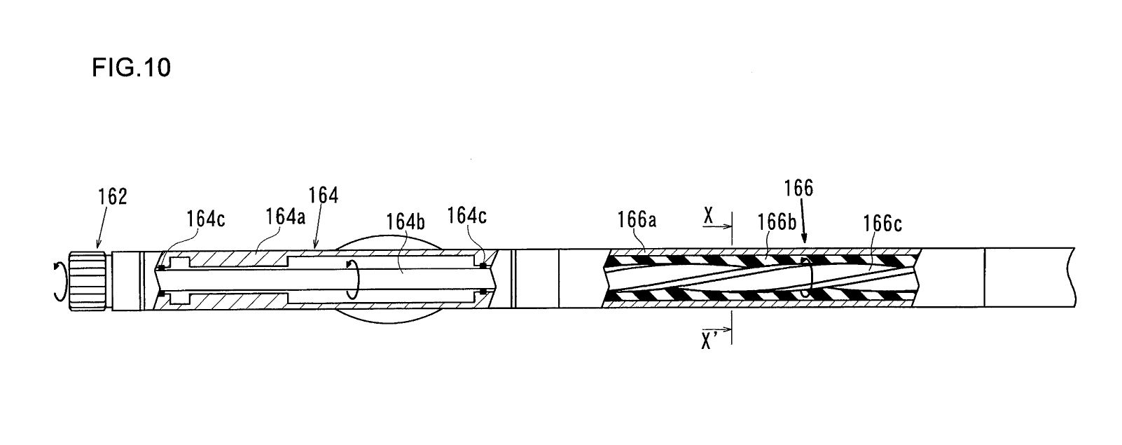

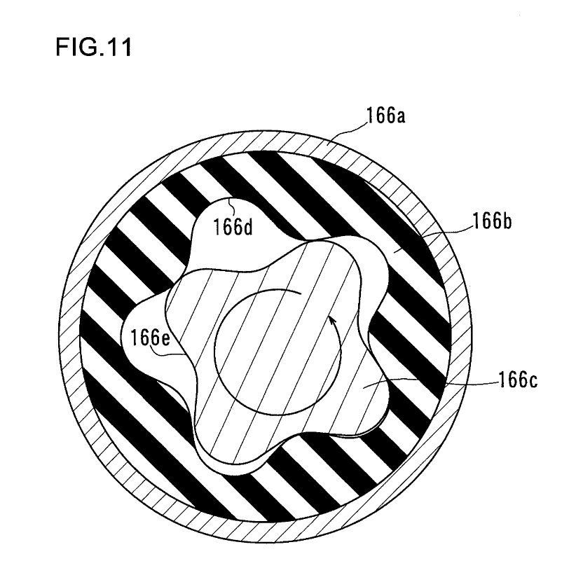

A dynamic seal member that is used for the logging tool is described below with reference to FIGS. 9 to 12. FIG. 9 is a cross-sectional view schematically illustrating a logging tool according to one embodiment of the invention that is used for subsea applications. FIG. 10 is a partial cross-sectional view schematically illustrating the logging tool according to one embodiment of the invention illustrated in FIG. 9. FIG. 11 is a cross-sectional view taken along the line X-X′ in FIG. 10 and schematically illustrating a mud motor of the logging tool. FIG. 12 is a cross-sectional view schematically illustrating a logging tool according to one embodiment of the invention that is used for underground applications.

As illustrated in FIG. 9, when probing undersea resources using a measuring instrument provided in a drilling assembly, a bottom hole assembly (BHA) 160 (i.e., logging tool) is caused to advance in a borehole 156 (vertical or horizontal passageway) formed in an ocean floor 154 from a platform 150 on the sea 152, and the underground structure and the like are probed to determine the presence or absence of the target substance (e.g., petroleum), for example. The bottom hole assembly 160 is secured on the end of a long drill string 153 that extends from the platform 150, for example, and includes a plurality of modules. For example, the bottom hole assembly 160 may include a drill bit 162, a rotary steerable system (RSS) 164, a mud motor 166, a measurement-while-drilling module 168, and a logging-while-drilling module 170 that are connected in this order from the end of the bottom hole assembly 160. The drill bit 162 is rotated (drills) at a bottom hole 156a of the borehole 156.

The rotary steerable system 164 illustrated in FIG. 10 includes a deviation mechanism (not shown) that causes the drill bit 162 to deviate in a given direction in a state in which the drill bit 162 rotates to enable directional drilling. The seal member described above (see “D. Seal member”) may be applied to the rotary steerable system 164 as a dynamic seal member. The rotary steerable system 164 requires a dynamic seal member that exhibits high abrasion resistance at about 210° C. or less, or a dynamic seal member that exhibits high chemical resistance against mud, for example. A related-art dynamic seal member may not properly function due to wear and tear of the rubber. This problem may be serious in a severe chemical environment. The dynamic seal member for a rotary steerable system disclosed in US2006/0157283 is required to function at a high sliding speed (100 mm/sec or less). However, the above problems of the dynamic seal member may be exacerbated by reduced properties of the elastomer at the usage temperature and the abrasive nature of the drilling fluid. On the other hand, when using the dynamic seal member as the dynamic seal member of the rotary steerable system 164, the above problems can be solved by high abrasion resistance for sealing drilling mud that contains particles, better chemical resistance against exposure to a wide range of drilling fluids, and better mechanical properties at a high temperature that reduce tearing in addition to the above properties of the dynamic seal member. The rotary steerable system 164 includes a cylindrical housing 164a that does not rotate, a transmission shaft 164b that is disposed through the housing 164a and transmits the rotational force of the mud motor 166 to the drill bit 162, and a dynamic seal member 164c that rotatably supports the transmission shaft 164b inside the housing 164a. The dynamic seal member 164c may be an endless O-ring that is fitted into a circular groove formed in the housing 164a, for example. The seal member 164c seals the space between the housing 164a and the surface of the rotating transmission shaft 164b. When using the dynamic seal member 164c is a seal member produced as described above (see “E. Oilfield applications”), the dynamic seal member 164c can maintain the sealing function for a long time since the dynamic seal member 164c exhibits excellent abrasion resistance in a severe underground environment at a high temperature (e.g., about 175° C. or less). For example, use of such a dynamic seal member is disclosed in US2006/0157283 and U.S. Pat. No. 7,188,685, the entire disclosure of which is incorporated by reference herein. Specifically, FIG. 5 of US2006/0157283 discloses a seal member 38 on a piston 36 that seals on a bore 30 in a bias unit of a rotary steerable assembly. U.S. Pat. No. 7,188,685 discloses a bias unit.

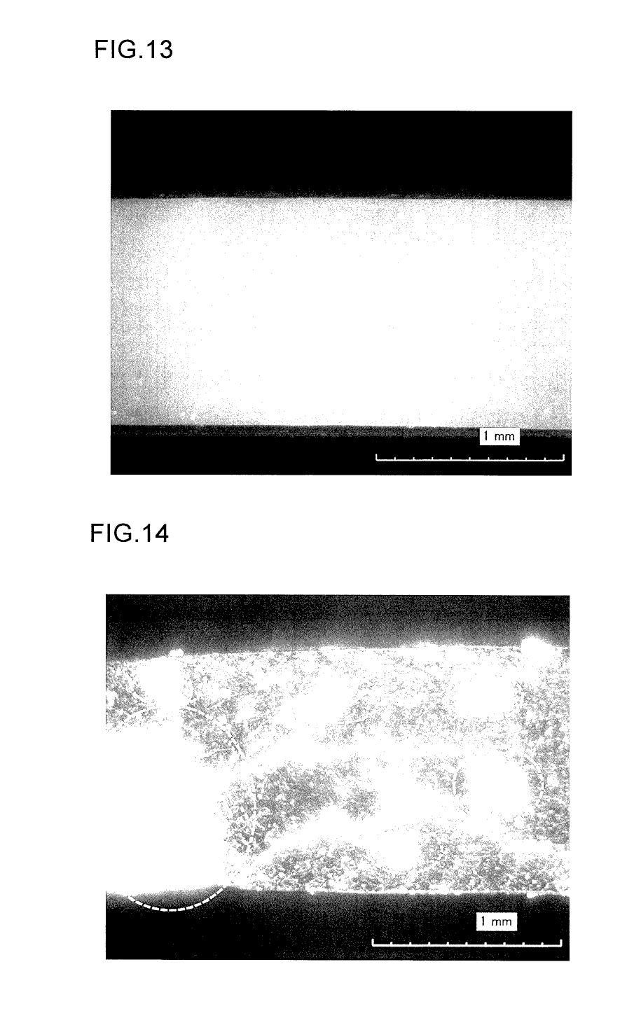

The mud motor 166 illustrated in FIG. 11 is also referred to as a downhole motor. The mud motor 166 is a fluid-driven motor that is driven by the flow of mud and rotates the drill bit 162. Examples of the mud motor 166 include a mud motor for deviated wellbore drilling applications. The seal member described above (see “D. Seal member”) may be applied to the mud motor 166 as a dynamic seal member. The mud motor 166 requires a dynamic seal member that exhibits high-temperature properties at about 150 to 200° C., a dynamic seal member that can function under extreme abrasive conditions, or a dynamic seal member that exhibits chemical resistance to handle a wide range of drilling muds, for example. A related-art dynamic seal member for a mud motor may swell, and may show seal failures from cracking and removal of large pieces of the sealing member body (chunking), seal failures from abrasion at a high temperature, and local heating and increased degradation of the dynamic seal member from the abrasive action of the dynamic seal member, for example. On the other hand, when using the seal member as the dynamic seal member of the mud motor 166, the above problems can be solved by better mechanical properties at a high temperature to reduce tearing and chunking, better chemical resistance against exposure to a wide range of drilling fluids, a reduction in local heat spots due to better thermal conductivity, and the like, in addition to the above properties of the dynamic seal member. The mud motor 166 includes a cylindrical housing 166a, a tubular stator 166b that is secured on the inner circumferential surface of the housing 166a, and a rotor 166c that is rotatably disposed inside a stator 166b. For example, five spiral grooves extend in an inner circumferential surface 166d of the stator 166b from the rotary steerable system 164 to the measurement-while-drilling module 168. The seal member that is produced as described above (see “D. Seal member”) may be used as the stator 166b. For example, an outer circumferential surface 166e of the rotor 166c formed of a metal has four threads that protrude spirally. The threads are disposed along the grooves formed in the inner circumferential surface 166d of the stator 166b. As illustrated in FIG. 11, the inner circumferential surface 166d of the stator 166b and the outer circumferential surface 166e of the rotor 166c partially come in contact with each other. A mud passage is formed inside an opening between the inner circumferential surface 166d and the outer circumferential surface 166e. Mud that flows through the opening comes in contact with the outer circumferential surface 166e of the rotor 166c so that the rotor 166c eccentrically rotates inside the stator 166b in the direction indicated by an arrow illustrated in FIGS. 10 and 11, for example. Since the inner circumferential surface 166d of the stator 166b comes in contact with the outer circumferential surface 166e of the rotor 166c and the rotor 166c eccentrically rotates due to mud, the inner circumferential surface 166d of the stator 166b functions in the same manner as a dynamic seal member. Since the stator 166b exhibits excellent abrasion resistance in a severe underground environment, the rotor 166c of the mud motor 166 can be rotated for a long time. Although this embodiment has been described above taking the mud motor 166 as an example of the fluid-driven motor, this embodiment may also be applied to another fluid-driven motor that has a similar structure and is driven using a fluid. The rotor may be formed of the seal member produced as described above (see “D. Seal member”), and the stator may be formed of a metal, for example. For example, use of such a dynamic seal member is disclosed in US2006/0216178 and U.S. Pat. No. 6,604,922, the entire disclosure of which is incorporated by reference herein. Specifically, FIG. 3 of US2006/0216178 discloses an elastomeric stator (lining) (i.e., dynamic seal member) that provides a sealing function against a rotor to generate drilling torque on the rotor. Mud flows between the stator and the rotor. FIG. 4 of US2006/0216178 discloses an elastomeric sleeve (i.e., dynamic seal member) that is attached to a rotor that provides a sealing function against a stator. FIG. 5 of US2006/0216178 discloses an elastomeric sleeve (i.e., dynamic seal member) on a rotor that provides a sealing function against a stator. FIG. 4 of U.S. Pat. No. 6,604,922 discloses that a resilient layer in a liner attached to a stator provides a sealing function. The resilient layer functions as a dynamic seal member. FIG. 13 of U.S. Pat. No. 6,604,922 discloses that a rotor lining formed by an elastomer layer provides a sealing function. The elastomer layer functions as a dynamic seal member.

The measurement-while-drilling module 168 includes a measurement-while-drilling instrument (not shown) that is disposed inside a chamber provided on a wall of a pipe (drill collar) that has a thick wall. The measurement-while-drilling instrument includes various sensors. For example, the measurement-while-drilling instrument measures bottom hole data (e.g., orientation, slope, bit direction, load, torque, temperature, and pressure), and transmits the measured data to the ground in real time.

The logging-while-drilling module 170 includes a logging-while-drilling instrument (not shown) that is disposed inside a chamber 170a provided on a wall of a pipe (drill collar) that has a thick wall. The logging-while-drilling instrument includes various sensors. For example, the logging-while-drilling instrument measures specific resistivity, porosity, acoustic wave velocity, gamma-rays, and the like to obtain physical logging data, and transmits the physical logging data to the ground in real time.

The seal member that is produced as described above (see “D. Seal member”) may be used for the measurement-while-drilling module 168 and the logging-while-drilling module 170 inside the chamber in order to protect the sensors from mud and the like.

As illustrated in FIG. 12, when probing underground resources from ground 155 using a measuring instrument provided in a drilling assembly, a platform and a derrick assembly 151 that are disposed over a borehole 156, and a bottom hole assembly (BHA) 160 (i.e., logging tool) that is disposed in a borehole 156 (vertical or horizontal passageway) formed under the derrick assembly 151 are used, for example. The derrick assembly 151 includes a hook 151a, a rotary swivel 151b, a kelly 151c, and a rotary table 151d. The bottom hole assembly 160 is secured on the end of a long drill string 153 that extends from the derrick assembly 151, for example. Mud is supplied to the drill string 153 from a pump (not shown) through the rotary swivel 151b to drive a fluid-driven motor of the bottom hole assembly 160. The bottom hole assembly 160 is basically the same as that of the logging tool for subsea applications described with reference to FIGS. 10 and 11. Therefore, description thereof is omitted. The seal member according to one embodiment of the invention may also be employed for the logging tool for underground applications. The above embodiment has been described taking an example in which the bottom hole assembly 160 includes the drill bit 162, the rotary steerable system 164, the mud motor 166, the measurement-while-drilling module 168, and the logging-while-drilling module 170. Note that the elements may be appropriately selected and combined depending on the logging application.

The oilfield application is not limited to the logging tool. For example, the seal member according to one embodiment of the invention may be used for a downhole tractor used for wireline log/logging. Examples of the downhole tractor include “MaxTRAC” or “TuffTRAC” (trademark; manufactured by Schlumberger Limited). The downhole tractor requires a reciprocating dynamic seal member having high abrasion resistance for longer operational life and reliability at about 175° C. or less.

A related-art dynamic seal member requires high polishing on the surface of a sealing piston provided in the downhole tractor. This leads to a high reject rate of the mirror-finished piston and cylinder surfaces during manufacturing. A related-art dynamic seal member based on standard elastomers leads to wear, leakage, reduced tool life and failures. A dynamic seal member may be subjected to a high sliding speed of up to 2000 ft/hour. A dynamic seal member used for the downhole tractor must function with hydraulic oil on both sides, or oil on one side and mud or other well fluids, possibly with particulates, on the other. A tractor job requires a sliding dynamic seal member to sufficiently function over a sliding length exceeding the tractoring distance. For example, a 10,000-ft tractoring job requires some of the dynamic seal members to reliably function over a cumulative sliding distance of 20,000 ft or less. Moreover, a differential pressure of 200 psi or less is applied across the dynamic seal member.

The above problems can be solved by utilizing the seal member described above (see “D. Seal member”) for the downhole tractor due to the above properties of the dynamic seal member. In particular, a relaxed finish on the sealing piston and cylindrical surfaces provides lower manufacturing costs. Moreover, superior wear resistance ensures longer life and a reliable seal function. In addition, lower friction allows longer seal life.

For example, use of such a dynamic seal member is disclosed in U.S. Pat. No. 6,179,055, the entire disclosure of which is incorporated by reference herein. Specifically, FIGS. 9A and 10A of U.S. Pat. No. 6,179,055 disclose a dynamic seal member on a piston. FIGS. 9B, 10B, and 12 of U.S. Pat. No. 6,179,055 also disclose a dynamic seal member on a piston. FIGS. 15, 12, and 16B of U.S. Pat. No. 6,179,055 disclose a dynamic seal member on a piston to seal against a tube and a housing. FIG. 16B of U.S. Pat. No. 6,179,055 discloses a dynamic seal member on a rod.

The seal member described above (see “D. Seal member”) may also be applied as a dynamic seal member to a formation testing and reservoir fluid sampling tool, for example. Examples of the formation testing and reservoir fluid sampling tool include “Modular Formation Dynamics Tester (MDT)” (trademark; manufactured by Schlumberger Limited). The formation testing and reservoir fluid sampling tool requires a dynamic seal member that exhibits high abrasion resistance in a pumpout module and other pistons. The formation testing and reservoir fluid sampling tool also requires a dynamic seal member that exhibits high abrasion resistance and high-temperature properties (210° C. or less) for sealing against the wellbore.

A piston in a displacement unit of a pumpout module sees a large number cycles (reciprocating motion) to move, extract, or pump a reservoir fluid for sampling, tool actuation, and analysis. A piston seal using a related-art dynamic seal member tends to wear, and fails after limited service life. This problem occurs to a large extent at a higher temperature. Moreover, particles in the fluid accelerate wear and damage of the dynamic seal member.

The above problems can be solved by utilizing the seal member for the formation testing and reservoir fluid sampling tool due to the above properties of the dynamic seal member. In particular, since the dynamic seal member exhibits high abrasion resistance at a higher temperature, seal life can be improved. The dynamic seal member that exhibits lower friction ensures less wear and better seal life. The dynamic seal member that exhibits better mechanical properties at a high temperature ensures better life and reliability. The dynamic seal member that exhibits better chemical resistance may be exposed to various well and produced fluids at a high temperature.

For example, use of such a dynamic seal member is disclosed in U.S. Pat. No. 6,058,773 and U.S. Pat. No. 3,653,436, the entire disclosure of which is incorporated by reference herein. Specifically, FIG. 2 of U.S. Pat. No. 6,058,773 discloses a reciprocating dynamic seal member on a shuttle piston in a displacement unit (DU) located in a pump-out module. FIGS. 2, 3, and 4 of U.S. Pat. No. 3,653,436 disclose an elastomeric element that seals against a wellbore surface lined with a mudcake.

The seal member described above (see “D. Seal member”) may also be applied to an in-situ fluid sampling bottle and an in-situ fluid analysis and sampling bottle as a dynamic seal member, for example. Such a bottle may be used for a formation testing/reservoir fluid sampling tool or a wireline log/logging tool, for example. The in-situ fluid sampling bottle and the in-situ fluid analysis and sampling bottle require a dynamic seal member that can be used at a high pressure at a low temperature and a high temperature. The in-situ fluid sampling bottle and the in-situ fluid analysis and sampling bottle require a dynamic seal member that exhibits high chemical resistance when exposed to a wide range of produced fluids. Moreover, the in-situ fluid sampling bottle and the in-situ fluid analysis and sampling bottle require a dynamic seal member that exhibits gas resistance.

When using the in-situ fluid sampling bottle or the in-situ fluid analysis and sampling bottle, a reservoir fluid is captured under in-situ reservoir conditions at a high temperature and a high pressure. When retrieving the bottle to the surface, the temperature drops while the pressure stays high. After retrieval, the sample is moved to other storage, shipping, or analysis containers. The dynamic seal member on a sliding piston in the sample bottle holds the following critical function during sample capture and sample export. For example, loss of the sample in situations (e.g., deep water fields) where low-temperature sealing for high pressure is not met when retrieved to the surface, loss of the sample at the surface during retrieval, loss of the sample from seal failures caused by chemical incompatibility with the sample and swelling from gas absorption issues, gas absorption in the seals that leads to swelling and increased friction/drag of the piston, extreme swelling of the dynamic seal member that may lead to sticking and seal failures/safety issues while transferring the sample from the bottle to other storage or analysis devices, and problems due to use of multiple sample bottles in a stack during the operation may occur. Loss of the sample at the surface during retrieval may lead to problems especially when the sample contains H₂S, CH₄, CO₂, and the like.

The above problems can be solved by utilizing the seal member described above (see “D. Seal member”) for the in-situ fluid sampling bottle and the in-situ fluid analysis and sampling bottle as a dynamic seal member due to high gas resistance, high chemical resistance, and good low-temperature sealing performance while satisfying high-temperature/high-pressure properties in addition to the above properties of the dynamic seal member.

For example, use of such a dynamic seal member is disclosed in U.S. Pat. No. 6,058,773, U.S. Pat. No. 4,860,581, and U.S. Pat. No. 6,467,544 (Brown et al.), the entire disclosure of which is incorporated by reference herein. Specifically, FIG. 7 of U.S. Pat. No. 6,058,773 discloses a dynamic seal member on a piston in a sample bottle. FIG. 2 of U.S. Pat. No. 4,860,581 discloses a two-bottle arrangement that includes a dynamic seal member on a piston in a sample bottle. FIG. 1 of U.S. Pat. No. 6,467,544 discloses a sealing and shut off valve.

The seal member described above (see “D. Seal member”) may also be applied to an in-situ fluid analysis tool (IFA) as a dynamic seal member, for example. The in-situ fluid analysis tool requires a dynamic seal member that exhibits high abrasion and gas resistance for downhole PVT. The term “PVT” means pressure/volume/temperature analysis. The in-situ fluid analysis tool requires a dynamic seal member that exhibits high chemical resistance for handling produced fluids. The in-situ fluid analysis tool also requires a flow line static dynamic seal member that exhibits high-temperature (about 210° C. or less)/high-pressure properties and high gas resistance. The term “flow line” refers to an area exposed to a sampled fluid.

For example, downhole PVT requires capturing a reservoir fluid sample and reducing the pressure to initiate gas formation and determine the bubble point. Depressurization is fast enough (e.g., greater than 3000 psi/min) so that a dynamic seal member that is directly connected to a PVT sample chamber may be subjected to explosive decompression. The dynamic seal member must be able to meet 200 or more PVT cycles. The dynamic seal member for downhole PVT may fail by gas due to explosive decompression. Therefore, a commercially available dynamic seal member does not allow downhole PVT at 210° C. A related-art dynamic seal member in a flow line may show integrity issues from swelling and blistering from gas permeation.

The above problems can be solved by utilizing the seal member described above (see “D. Seal member”) for the in-situ fluid analysis tool as a dynamic seal member. The dynamic seal member that exhibits better mechanical properties at high temperature and high pressure can reduce a swelling tendency. The dynamic seal member in which voids are reduced by the oxycellulose fibers or the cellulose nanofibers exhibits high gas resistance. The dynamic seal member with improved material properties exhibits high resistance to swelling and explosive decompression. The dynamic seal member that exhibits high chemical resistance improves chemical resistance against a wide range of produced fluids.

For example, use of such a dynamic seal member is disclosed in US2009/0078412, U.S. Pat. No. 6,758,090, U.S. Pat. No. 4,782,695, and U.S. Pat. No. 7,461,547, the entire disclosure of which is incorporated by reference herein. Specifically, FIG. 7 of US2009/0078412 discloses a dynamic seal member on a valve, and FIG. 5 of US2009/0078412 discloses a dynamic seal member on a piston seal unit. FIG. 21a of U.S. Pat. No. 6,758,090 discloses a dynamic seal member on a valve and a piston. U.S. Pat. No. 4,782,695 discloses a dynamic seal member between a needle and a PVT chamber. U.S. Pat. No. 7,461,547 discloses a dynamic seal member on a valve for isolating a fluid in PVCU as a dynamic seal member in a piston-sleeve arrangement in a pressure volume control unit (PVCU) for PVT analysis.

The seal member described above (see “D. Seal member”) may also be applied to all tools used for wireline log/logging, logging while drilling, well testing, perforation, and sampling operations as a dynamic seal member, for example. Such a tool requires a dynamic seal member that enables high-pressure sealing at a low temperature and a high temperature.

Such a tool requires a dynamic seal member that works over a wide temperature range from a low temperature to a high temperature when used in deep water. When the dynamic seal member does not properly work at a low temperature, leakage into air chambers such as electronic sections and tool failure may occur. A sampling operation in deepwater or cold areas such as the North Sea requires the dynamic seal member to function over a wide temperature range from a low temperature to a high temperature. Specifically, the sample is still at a high temperature when the sample is retrieved, while the temperature drops to that of the surface conditions. For example, poor low-temperature sealing at a high pressure may lead to sample leakage, loss, and other problems. Since many of the tools are filled with hydraulic oil and pressurized to 100 to 200 psi, the tools may leak oil under cold surface conditions, or problems may occur during retrieval from the cold deep water section when the dynamic seal member does not function well at a low temperature.

The above problems can be solved by utilizing the seal member described above (see “D. Seal member”) for the above tools as a dynamic seal member due to good low-temperature sealing performance, and better sealing capability at high temperature and high pressure due to better high-temperature mechanical properties in addition to the above properties of the dynamic seal member.

The seal member described above (see “D. Seal member”) may also be applied to a side wall coring tool as a dynamic seal member, for example. The side wall coring tool requires a dynamic seal member that exhibits lower friction and high abrasion resistance, a dynamic seal member that has long life and high seal reliability, a dynamic seal member that exhibits high-temperature (up to about 200° C.) properties, or a dynamic seal member that has a value delta P of 100 psi or less (low speed sliding), for example. The term “delta P” refers to a pressure difference across the dynamic seal member of the piston. For example, the value delta P decreases (i.e., the piston can be moved with a small pressure difference) when the dynamic seal member has low friction.

For example, when the dynamic seal member causes sticking or increased frictional force, the side wall coring tool may stop the coring operation. Drilling of each core requires the drill bit to rotate and slide by engaging with the dynamic seal member while cutting into the formation. The dynamic seal member must have low sealing friction in order to maintain a high core drilling efficiency.

The above problems can be solved by utilizing the seal member described above (see “D. Seal member”) for the side wall coring tool as a dynamic seal member due to the following properties in addition to the above properties of the dynamic seal member. The dynamic seal member with low friction can reduce power consumption for the core drilling operation and actuation/movement. The dynamic seal member with low friction shows less tendency for sticking and rolling thus improving the efficiency of the core drilling operation. The dynamic seal member that exhibits high abrasion resistance can improve seal life in abrasive well fluids.

For example, use of such a dynamic seal member is disclosed in US2009/0133932, U.S. Pat. No. 4,714,119, and U.S. Pat. No. 7,191,831, the entire disclosure of which is incorporated by reference herein. Specifically, FIGS. 4 and 5 of US2009/0133932 disclose a dynamic seal member on a coring bit in a coring assembly driven by a motor. FIGS. 3B, 7, and 8 of U.S. Pat. No. 4,714,119 disclose a dynamic seal member on a drill bit driven by a motor at 2000 rpm or less to advance and cut a core from a borehole. FIGS. 2A and 2B of U.S. Pat. No. 7,191,831 disclose a dynamic seal member between a coring bit and a coring assembly driven by a motor. A high efficiency can be achieved by utilizing a low-friction dynamic seal member such as the dynamic seal member according to this embodiment at the interface between parts 201 to 204 (see FIGS. 3 and 4) or between a bit and a housing illustrated in FIG. 8B.

The seal member described above (see “D. Seal member”) may also be applied to a telemetry and power generation tool in drilling applications as a dynamic seal member, for example. The telemetry and power generation tool requires a rotating dynamic seal member that exhibits high abrasion resistance, a rotating/sliding dynamic seal member that exhibits low friction, or a dynamic seal member that exhibits high-temperature (up to about 175° C.) properties, for example.

A mud pulse telemetry device such as disclosed in U.S. Pat. No. 7,083,008 depends on a rotary dynamic seal member that protects the oil filled tool interior from the external well fluids (drilling mud), for example. However, since particulates are contained in the well fluids, wear and tear of the dynamic seal member tend to increase. Seal failure from abrasion and wear of the dynamic seal member may lead to mud invasion and tool failure. The telemetry and power tool disclosed in U.S. Pat. No. 7,083,008 works with a sliding dynamic seal member on a piston that compensates the internal oil pressure with external fluids, and wear, abrasion, swelling, and sticking of the dynamic seal member may lead to failure through external fluid invasion in the tool.

The above problems can be solved by utilizing the seal member described above (see “D. Seal member”) for the telemetry and power generation tool as a dynamic seal member due to better abrasion resistance and lower friction that allow more reliable operations and longer seal life in addition to the above properties of the dynamic seal member.

For example, use of such a dynamic seal member is disclosed in U.S. Pat. No. 7,083,008, the entire disclosure of which is incorporated by reference herein. Specifically, FIG. 2 of U.S. Pat. No. 7,083,008 discloses a rotary dynamic seal member in a seal/bearing assembly between rotors, and FIG. 3a of U.S. Pat. No. 7,083,008 discloses a sliding dynamic seal member on a compensating piston that separates oil and a well fluid in a pressure compensating chamber.

The seal member described above (see “D. Seal member”) may also be applied to an inflate packer that is used for isolating part of a wellbore for sampling and formation testing, as a dynamic seal member, for example. A dynamic seal member of the inflate packer must have high abrasion strength and high-temperature properties to allow repeated inflation-deflation operations at multiple wellbore locations.

A related-art packer dynamic seal member tends to degrade and fail in sealing function due to the absence of desirable high-temperature properties. A related-art packer dynamic seal member may show less than desirable life.

The above problems can be solved by utilizing the seal member described above (see “D. Seal member”) as a dynamic seal member for the inflate packer due to better abrasion resistance and better high-temperature properties so that the life and the reliability of the packing element can be improved.

For example, use of such a dynamic seal member is disclosed in U.S. Pat. No. 7,578,342, U.S. Pat. No. 4,860,581, and U.S. Pat. No. 7,392,851, the entire disclosure of which is incorporated by reference herein. Specifically, FIGS. 1A, 1B, and 1C of U.S. Pat. No. 7,578,342 disclose that a dynamic seal member inflates to seal against a borehole, and isolates a section indicated by reference numeral 16. An elastomer sealing element (packing element) illustrated in FIG. 4A of U.S. Pat. No. 7,578,342, or a member indicated by reference numeral 712 or 812 in FIGS. 7 and 8 of U.S. Pat. No. 7,578,342 corresponds to the dynamic seal member. FIG. 1 of U.S. Pat. No. 4,860,581 discloses an inflate packing element that seals against a wellbore. U.S. Pat. No. 7,392,851 discloses an inflate packing element.

Although only some embodiments of this invention have been described in detail above, those skilled in the art will readily appreciate that many modifications are possible in the embodiments without materially departing from the novel teachings and advantages of this invention. Accordingly, all such modifications are intended to be included within the scope of the invention.

Examples of the invention will be described below, but the invention is not limited thereto.

### (1-1) Preparation of Samples of Examples 1 to 4

### Aqueous Solution Preparation Step

Oxycellulose fibers and cellulose nanofibers were obtained using the method disclosed in Production Example 1 of JP-A-2013-18918.

Specifically, bleached conifer kraft pulp was sufficiently stirred in ion-exchanged water, and 1.25 mass % of TEMPO, 12.5 mass % of sodium bromide, and 28.4 mass % of sodium hypochlorite were sequentially added to 100 g of the pulp at 20° C. The pH of the mixture was adjusted to 10.5 by adding sodium hydroxide dropwise to the mixture to effect an oxidation reaction. When 120 minutes had elapsed, the dropwise addition of sodium hydroxide was stopped to obtain an aqueous solution including 10 mass % of TEMPO-oxidized oxycellulose fibers. The oxycellulose fibers had a fiber diameter of 10 to 30 micrometers and a fiber length of 1 to 5 mm (similar to those of the pulp).

The oxycellulose fibers were sufficiently washed with ion-exchanged water, and dehydrated. The solid content in the oxycellulose fibers was adjusted to 1 mass % using ion-exchanged water, and the oxycellulose fibers were miniaturized using a high-pressure homogenizer to obtain an aqueous dispersion including 1 mass % of cellulose nanofibers. The cellulose nanofibers had an average fiber diameter of 3.3 nm and an average aspect ratio of 225.

### Mixing Step

A hydrogenated nitrile rubber (hereinafter referred to as “H-NBR”) latex (“ZLx-B” manufactured by Zeon Corporation (aqueous dispersion having a solid content of 40 mass %)) was added to the aqueous dispersion including 1 mass % of the cellulose nanofibers, and the mixture was mixed using a juicer mixer (rotational speed: 10,000 rpm) to obtain a first mixture.

In Examples 2 to 4, the mixture was further mixed using a triple roll mill (M-50) (manufactured by EXAKT) in which the nip was set to 10 micrometers (rotational speed: 200 rpm) to obtain a first mixture.

### Drying Step

The first mixture was heated and dried for 4 days in an oven that was set to 50° C. to obtain a second mixture. The ratio (amount) of the components in the second mixture obtained by drying is listed in Table 1. Note that the unit for the amount shown in Tables 1 to 3 is parts by mass (phr).

### Dispersion Step

The second mixture was masticated at a roll distance of 1.5 mm, supplied to an open roll (roll distance: 0.3 mm), and tight-milled at 10 to 30° C. to obtain a rubber composition sample. The surface velocity ratio of the rolls was set to 1.1. The second mixture was repeatedly tight-milled five times.

### Vulcanization Step

8 parts by mass of a peroxide (cross-linking agent) was added to the rubber composition sample obtained by tight milling, and the mixture was sheeted, and compression-molded at 170° C. for 10 minutes to obtain a sheet-shaped cross-linked rubber composition sample (thickness: 1 mm).

TABLE 1

| | Example 1 | Example 2 | Example 3 | Example 4 |
|---|---|---|---|---|
| H-NBR latex | 100 | 100 | 100 | 100 |
| (dry weight) | | | | |
| Cellulose nanofibers | 20 | 5 | 10 | 20 |

### (1-2) Preparation of Samples of Examples 5 to 7

### Mixing Step

An H-NBR latex (“ZLx-B” manufactured by Zeon Corporation) was added to an aqueous dispersion including 1 mass % of the TEMPO-oxidized oxycellulose fibers, and the mixture was mixed using a juicer mixer (rotational speed: 10,000 rpm) to obtain a first mixture.

In Examples 6 and 7, the mixture was further mixed using a triple roll mill (M-50) (manufactured by EXAKT) in which the nip was set to 10 micrometers (rotational speed: 200 rpm) to obtain a first mixture.

### Drying Step

The first mixture was heated and dried for 4 days in an oven that was set to 50° C. to obtain a second mixture. The ratio (amount) of the components included in the second mixture obtained by drying is listed in Table 2.

### Dispersion Step

The second mixture was masticated at a roll distance of 1.5 mm, supplied to an open roll (roll distance: 0.3 mm), and tight-milled at 10 to 30° C. to obtain a rubber composition sample. The surface velocity ratio of the rolls was set to 1.1. The second mixture was repeatedly tight-milled five times.

### Vulcanization Step

8 parts by mass of a peroxide (cross-linking agent) was added to the rubber composition sample obtained by tight milling, and the mixture was sheeted, and compression-molded at 170° C. for 10 minutes to obtain a sheet-shaped cross-linked rubber composition sample (thickness: 1 mm).

TABLE 2

| | Example 5 | Example 6 | Example 7 |
|---|---|---|---|
| H-NBR latex | 100 | 100 | 100 |
| (dry weight) | | | |
| Oxycellulose fibers | 10 | 5 | 10 |

### (1-3) Preparation of Samples of Examples 8 to 10

Sheet-shaped cross-linked rubber composition samples of Examples 8 and 9 were obtained in the same manner as in Example 4 (see (1-1)), except that a homogenizer (Example 8) or a rotary stirrer (Example 9) was used in the mixing step instead of the triple roll mill. The ratio (amount) of the components used in Examples 8 and 9 is listed in Table 3.

In Example 8, a homogenizer “US-300TS” (manufactured by Nihonseiki Kaisha Ltd.) was used as the homogenizer, and the mixture was mixed at 300 W for 20 minutes. In Example 9, a planetary centrifugal mixer “ARE-310” (manufactured by THINKY Corporation) was used as the rotary stirrer, and the mixture was mixed at 2,000 rpm for 5 minutes.

A sheet-shaped cross-linked rubber composition sample of Example 10 was obtained in the same manner as in Example 4 (see (1-1)), except that a coagulation step was performed between the mixing step and the drying step, and the drying step was performed for 2 days (i.e., the drying time was reduced by 2 days as compared with Example 4). The ratio (amount) of the components used in Example 10 is listed in Table 3.

In the coagulation step, a coagulant (5 parts by mass based on 100 parts by mass of the rubber component included in the first mixture) was added to the first mixture (aqueous solution) obtained by the mixing step in the same manner as in Example 4, and the mixture was stirred (mixed). The rubber component was coagulated by the coagulant. The resulting coagulate was repeatedly dehydrated and washed with water (three times).

The coagulate was dehydrated using a rotary dehydrator. A 20% solution of a cyclohexylamine salt of acetic acid in methanol was used as the coagulant.

TABLE 3

| | Example 8 | Example 9 | Example 10 |
|---|---|---|---|
| H-NBR latex | 100 | 100 | 100 |
| (dry weight) | | | |
| Cellulose nanofibers | 20 | 20 | 5 |

### (1-4) Preparation of Samples of Comparative Examples 1 to 5

In Comparative Example 1, an H-NBR latex (“ZLx-B” manufactured by Zeon Corporation) was heated and dried for several days in an oven that was set to 50° C. to obtain a sample (pure rubber).

In Comparative Example 2, a sample was prepared in the same manner as in the examples of JP-A-2013-18918 (see below).

An aqueous solution including 1 mass % of TEMPO-oxidized oxycellulose fibers was subjected to a miniaturization process twice at 245 MPa using a high-pressure homogenizer (“Star Burst Labo HJP-25005” manufactured by Sugino Machine Ltd.) to obtain an aqueous solution including 1 mass % of cellulose nanofibers. An H-NBR latex (“ZLx-B” manufactured by Zeon Corporation) was added to the aqueous dispersion including 1 mass % of the cellulose nanofibers, and the mixture was mixed using a juicer mixer (rotational speed: 10,000 rpm), and heated and dried for 4 days in an oven that was set to 50° C. to obtain a mixture including 50 mass % of the cellulose nanofibers. The ratio (amount) of the components included in the mixture obtained by drying is listed in Table 4.

The mixture was supplied to a triple roll mill, and dried. After the addition of an H-NBR latex in the amount listed in Table 4, the mixture was mixed, dried, and mixed using an open roll (roll distance: 1.5 mm) After the addition of 8 parts by weight of a peroxide (cross-linking agent), the mixture was sheeted, and compression-molded at 170° C. for 10 minutes to obtain a sheet-shaped cross-linked rubber composition sample (thickness: 1 mm).

In Comparative Examples 3 to 5, SAF grade carbon black (“CB” in Table 4) was supplied to an open roll (roll distance: 0.3 mm) in the ratio listed in Table 4, followed by tight milling to obtain a rubber composition. The rubber composition sample was cross-linked in the same manner as described above.

TABLE 4

| | Com- | Com- | Com- | Com- | Com- |
|---|---|---|---|---|---|
| | parative | parative | parative | parative | parative |
| | Example 1 | Example 2 | Example 3 | Example 4 | Example 5 |
| H-NBR latex | 100 | 10 | 100 | 100 | 100 |
| (dry weight) | | | | | |
| Cellulose | 0 | 10 | 0 | 0 | 0 |
| nanofibers | | | | | |
| CB | 0 | 0 | 10 | 20 | 60 |
| additional | 0 | 90 | 0 | 0 | 0 |
| H-NBR latex | | | | | |
| (dry weight) | | | | | |

### (2-1) Basic Property Test

The rubber hardness (Hs (JIS A)) of the rubber composition sample was measured in accordance with JIS K 6253.

A specimen was prepared by punching the rubber composition sample in the shape of a JIS No. 6 dumbbell. The specimen was subjected to a tensile test in accordance with JIS K 6251 at a temperature of 23±2° C. and a tensile rate of 500 mm/min using a tensile tester (manufactured by Shimadzu Corporation) to measure the tensile strength (TS (MPa)), the elongation at break (Eb (%)), the 50% modulus (G50 (MPa)), and the 100% modulus (σ100 (MPa)).

A JIS K 6252 angle specimen (uncut) was prepared using the rubber composition sample. The specimen was subjected to a tear test in accordance with JIS K 6252 at a tensile rate of 500 mm/min using an instrument “Autograph AG-X” (manufactured by Shimadzu Corporation) to measure the maximum tearing force (N) to determine the tear strength (Tr (N/mm)).

A strip-shaped specimen (40×1×2 (width) mm) was prepared using the rubber composition sample. The specimen was subjected to a dynamic viscoelasticity test in accordance with JIS K 6394 using a dynamic viscoelasticity tester (“DMS6100” manufactured by SII) at a chuck distance of 20 mm, a measurement temperature of −100 to 300° C. (heating rate: 3° C./min), a dynamic strain of ±0.05%, and a frequency of 1 Hz to measure the storage modulus (E′ (MPa)) at a temperature range of −50° C. to 260° C. The measurement results are listed in Tables 5 to 7.

TABLE 5

| | | Example 1 | Example 2 | Example 3 | Example 4 | Example 5 |
|---|---|---|---|---|---|---|
| Hs | JISA | 82 | 66 | 70 | 81 | 67 |
| TS | MPa | 21.0 | 14.5 | 15.3 | 22.2 | 17.5 |
| Eb | % | 390 | 390 | 380 | 340 | 420 |
| σ50 | MPa | 4.9 | 1.5 | 2.5 | 5.8 | 1.5 |
| σ100 | MPa | 7.6 | 2.1 | 3.7 | 9.9 | 1.8 |
| Tr | N/mm | 57.6 | 31.5 | 45.1 | 65.1 | 30.0 |
| E′ (25° C.) | MPa | 44.2 | 9.2 | 14.6 | 53.4 | 7.2 |
| E′ (150° C.) | MPa | 41.9 | 6.3 | 9.4 | 38.0 | 5.1 |
| E′ (175° C.) | MPa | 34.0 | 5.9 | 8.2 | 33.3 | 5.0 |
| E′ (200° C.) | MPa | 24.2 | 5.3 | 6.6 | 23.1 | 4.8 |
| Volume resistivity | ohm-cm | 9.1E+08 | 2.0E+08 | 1.1E+08 | 1.4E+09 | 1.1E+08 |

TABLE 6

| | | Example 6 | Example 7 | Example 8 | Example 9 | Example 10 |
|---|---|---|---|---|---|---|
| Hs | JISA | 62 | 68 | 85 | 85 | 67 |
| TS | MPa | 10.9 | 18.7 | 24.4 | 25.9 | 23.6 |
| Eb | % | 400 | 430 | 350 | 390 | 590 |
| σ50 | MPa | 1.3 | 2.2 | 6.6 | 5.8 | 1.6 |
| σ100 | MPa | 1.8 | 3.4 | 11.3 | 9.6 | 2.1 |
| Tr | N/mm | 27.7 | 33.8 | 89.3 | 86.6 | 31.5 |
| E′ (25° C.) | MPa | 5.3 | 8.0 | 66.3 | 56.0 | 8.1 |
| E′ (150° C.) | MPa | 3.5 | 5.2 | 37.2 | 31.1 | 5.3 |
| E′ (175° C.) | MPa | 3.5 | 5.1 | 31.8 | 26.7 | 5.1 |
| E′ (200° C.) | MPa | 3.6 | 5.0 | 22.6 | 19.5 | 4.5 |
| Volume resistivity | ohm-cm | 1.1E+08 | 9.2E+09 | 4.1E+08 | 3.5E+08 | 2.2E+08 |

TABLE 7

| | | Comparative | Comparative | Comparative | Comparative | Comparative |
|---|---|---|---|---|---|---|
| | | Example 1 | Example 2 | Example 3 | Example 4 | Example 5 |
| Hs | JISA | 55 | 65 | 60 | 66 | 85 |
| TS | MPa | 14.0 | 14.3 | 19.0 | 25.5 | 31.3 |
| Eb | % | 400 | 390 | 320 | 280 | 180 |
| σ50 | MPa | 1.0 | 1.7 | 1.2 | 1.6 | 4.3 |
| σ100 | MPa | 1.2 | 2.0 | 1.6 | 2.6 | 10.1 |
| Tr | N/mm | 20.4 | 35.0 | 33.8 | 40.3 | 45.4 |
| E′ (25° C.) | MPa | 3.4 | 10.8 | 4.4 | 6.2 | 43.5 |
| E′ (150° C.) | MPa | 2.5 | 6.7 | 3.0 | 3.0 | 11.6 |
| E′ (175° C.) | MPa | 2.6 | 5.8 | 3.1 | 3.1 | 10.8 |
| E′ (200° C.) | MPa | 2.7 | 4.5 | 3.2 | 3.2 | 10.3 |
| Volume resistivity | ohm-cm | 5.9E+09 | 3.3E+08 | 5.0E+09 | 1.1E+09 | 4.8E+02 |

As is clear from the results listed in Tables 5 and 7, the rubber compositions of Examples 1 to 4 that were reinforced by the cellulose nanofibers exhibited improved tensile strength, 50% modulus, 100% modulus, tear strength, and storage modulus. In particular, the rubber composition of Example 3 exhibited improved tensile strength, 50% modulus, 100% modulus, tear strength, and storage modulus as compared with the rubber composition of Comparative Example 2 including the cellulose nanofibers in a ratio of 10 parts by mass.

As is clear from the results listed in Tables 5 and 6, the rubber compositions of Examples 5 to 7 that were reinforced by the oxycellulose fibers exhibited improved tensile strength, 50% modulus, 100% modulus, tear strength, and storage modulus.

As is clear from the results listed in Tables 6 and 7, the rubber compositions of Examples 8 and 9 that were reinforced by the cellulose nanofibers exhibited improved tensile strength, 50% modulus, 100% modulus, tearing strength, and storage modulus as compared with the rubber compositions of Comparative Examples 1 and 2. The rubber compositions of Examples 8 and 9 exhibited slightly low storage modulus at 150 to 200° C. as compared the rubber composition of Example 4 in which the mixture was mixed using the triple roll mill.

As is clear from the results listed in Tables 6 and 7, the rubber composition of Example 10 that was reinforced by the cellulose nanofibers exhibited improved tensile strength, 50% modulus, 100% modulus, tearing strength, and storage modulus as compared with the rubber compositions of Comparative Examples 1 and 2.

### (2-2) Measurement of Volume Resistivity

The volume resistivity (ohm-cm) at 23° C. of the rubber composition sample (width: 50 mm, length: 50 mm, thickness: 1 mm) was measured in accordance with JIS K 6271. The measurement results are listed in Tables 5 to 7.

As is clear from the results listed in Tables 6 and 7, the rubber compositions of Examples 1 to 10 exhibited high insulation performance comparable to that of the sample (pure rubber) of Comparative Example 1 while being reinforced by a small amount of cellulose nanofibers or oxycellulose fibers. Regarding the samples of Comparative Examples 3 to 5, it was necessary to increase the amount of carbon black in order to obtain a reinforcing effect. However, the insulation performance was impaired as a result of increasing the amount of carbon black.

### (2-3) Observation Using Optical Microscope

The fracture surface of the rubber composition sample subjected to the tensile test was observed using an optical microscope (“Digital Microscope KG-7700” manufactured by Hirox) to determine the presence or absence of an aggregate of the cellulose nanofibers or the oxycellulose fibers.

No aggregate was observed in the rubber composition samples of Examples 1 to 10. On the other hand, a number of aggregates having a diameter of 0.1 mm or more were observed in the rubber composition sample of Comparative Example 2.

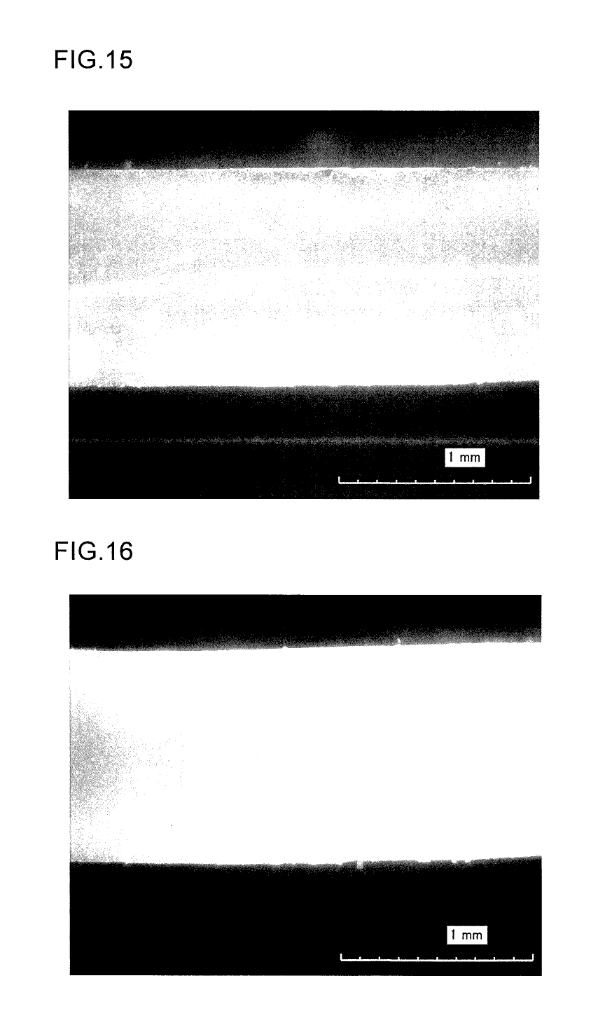

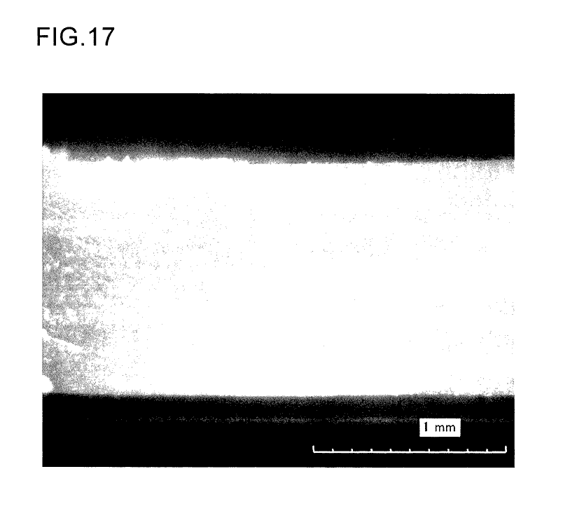

FIG. 13 illustrates an optical micrograph of the rubber composition of Comparative Example 1. FIG. 14 illustrates an optical micrograph of the rubber composition of Comparative Example 2. FIG. 15 illustrates an optical micrograph of the rubber composition of Example 1. FIG. 16 illustrates an optical micrograph of the rubber composition of Example 4. FIG. 17 illustrates an optical micrograph of the rubber composition of Example 7. In FIGS. 13 to 17, the gray area situated between the upper black area and the lower black area corresponds to the rubber composition sample.

An aggregate of the cellulose nanofibers is not observed in the rubber composition samples illustrated in FIGS. 13 and 15 to 17. On the other hand, white aggregates of the cellulose nanofibers are observed in the rubber composition sample illustrated in FIG. 14 (see the areas enclosed by the broken line).

### (2-4) Tear Fatigue Life Test

A specimen was prepared by punching the rubber composition sample in the shape of a strip (10 mm×4 mm (width)×1 mm (thickness)) (the long side was the grain direction). A cut (depth: 1 mm) was formed in the specimen in the widthwise direction from the center of the long side using a razor blade. The specimen was subjected to a tear fatigue test using a tester “TMA/SS6100” (manufactured by SII) by repeatedly applying a tensile load (1 to 4 N/mm) to the specimen in air at a temperature of 120° C. and a frequency of 1 Hz in a state in which each end of the specimen was held using a chuck in the vicinity of the short side to measure the number of times that the tensile load was applied until the specimen broke to determine the tear fatigue life (see “Number of tear fatigue cycles” in Tables 8 to 10). The tensile load was applied up to 200,000 times when the specimen did not break. The measurement results are listed in Tables 8 to 10.

TABLE 8

| | Load | | Example 1 | Example 2 | Example 3 | Example 4 | Example 5 |
|---|---|---|---|---|---|---|---|
| Number of tear | 1.0 | N/mm | — | 5,730 | 200,000 | — | 9,500 |
| fatigue cycles | 2.0 | N/mm | 200,000 | 130 | 700 | 200,000 | 50 |
| | 3.0 | N/mm | 31,840 | 20 | 50 | 38,360 | 6 |
| | 4.0 | N/mm | 160 | 1 | 20 | 120 | — |

TABLE 9

| | Load | | Example 6 | Example 7 | Example 8 | Example 9 | Example 10 |
|---|---|---|---|---|---|---|---|
| Number of tear | 1.0 | N/mm | 3,310 | 10,360 | — | — | 4,830 |
| fatigue cycles | 2.0 | N/mm | 20 | 80 | 200,000 | 200,000 | 120 |
| | 3.0 | N/mm | 1 | 10 | 27,550 | 30,210 | 10 |
| | 4.0 | N/mm | — | 1 | 100 | 110 | 1 |

TABLE 10

| | | | Comparative | Comparative | Comparative | Comparative | Comparative |
|---|---|---|---|---|---|---|---|
| | Load | | Example 1 | Example 2 | Example 3 | Example 4 | Example 5 |
| Number of tear | 1.0 | N/mm | 430 | 2,300 | 1,200 | 4,200 | 200,000 |
| fatigue cycles | 2.0 | N/mm | 1 | 50 | 10 | 70 | 15,700 |
| | 3.0 | N/mm | — | 1 | 1 | 1 | 2,100 |
| | 4.0 | N/mm | — | — | — | — | 1,200 |

As is clear from the results listed in Tables 8 and 10, the rubber compositions of Examples 1 to 4 that were reinforced by the cellulose nanofibers exhibited an improved tear fatigue life. In particular, the rubber composition of Example 3 exhibited an improved tear fatigue life as compared with the rubber composition of Comparative Example 2 including the cellulose nanofibers in a ratio of 10 parts by mass.

As is clear from the results listed in Tables 8 and 9, the rubber compositions of Examples 5 to 7 that were reinforced by the cellulose nanofibers exhibited an improved tear fatigue life.

As is clear from the results listed in Tables 9 and 10, the rubber compositions of Examples 8 and 9 that were reinforced by the cellulose nanofibers exhibited an improved tear fatigue life as compared with the rubber compositions of Comparative Examples 1 and 2. When subjecting the rubber compositions of Examples 8 and 9 to the tear fatigue life test, the number of times that the tensile load was applied until the specimen broke was small as compared with the rubber composition of Example 4 when the load was 3.0 or 4.0 N/mm.

As is clear from the results listed in Tables 9 and 10, the rubber composition of Example 10 that was reinforced by the cellulose nanofibers exhibited an improved tear fatigue life as compared with the rubber compositions of Comparative Examples 1 and 2.

### (2-5) Thermal Properties

The rubber composition samples of Examples 2 to 4 and the samples of Comparative Examples 1, 4, and 5 were subjected to a tensile test as described above (see “(2-1) Basic property test”) at a high temperature (atmospheric temperature: 120° C.) to measure the tensile strength (TS (MPa)), the elongation at break (Eb (%)), the 50% modulus (σ50 (MPa)), the 100% modulus (σ100 (MPa)), and the tear strength (Tr (N/mm)). A change ratio (thermal property change ratio (e.g., ΔTS)=(property at 120° C.−property at 23° C.)/property at 23° C.×100) was calculated based on the high-temperature measurement results and the measurement results obtained as described above (see “(2-1) Basic property test”). The measurement results are listed in Table 11 (see “ΔTS”, “ΔEb”, “Δσ50”, “Δσ100”, and “ΔTr”).

TABLE 11

| | | Comparative | Comparative | Comparative | | | |
|---|---|---|---|---|---|---|---|
| | | Example 1 | Example 4 | Example 5 | Example 2 | Example 3 | Example 4 |
| ΔTS | % | −19 | 24 | 11 | 19 | 16 | 7 |
| ΔEb | % | −4 | 13 | 15 | −4 | −10 | −20 |
| Δσ50 | % | −8 | −11 | −30 | 32 | 29 | 17 |
| Δσ100 | % | −1 | −15 | −45 | 46 | 36 | 18 |
| ΔTr | % | −4 | −26 | −32 | −24 | −2 | −4 |

As is clear from the results listed in Table 11, the rubber compositions of Examples 2 to 4 showed a small change in 50% modulus (σ50), 100% modulus (σ100), and tear strength (Tr) (i.e., maintained excellent properties even at a high temperature) as compared with the samples of Comparative Examples 1, 4, and 5. The rubber compositions of Examples 2 to 4 showed a decrease in elongation at break (Eb). Note that the rubber compositions of Examples 2 to 4 had a high elongation at break (Eb) at 23° C., and had a high elongation at break (Eb) even at a high temperature as compared with the samples of Comparative Examples 1, 4, and 5.

What is claimed is:

1. An oilfield apparatus comprising a seal member that is formed of a rubber composition that includes a rubber, and at least either oxycellulose fibers or cellulose nanofibers that are dispersed in the rubber in an untangled state, and does not include an aggregate that includes at least either the oxycellulose fibers or the cellulose nanofibers and has a diameter of 0.1 mm or more,
the rubber composition including at least either the oxycellulose fibers or the cellulose nanofibers in a ratio of 1 to 60 parts by mass based on 100 parts by mass of the rubber,
the oxycellulose fibers having an average fiber diameter of 10 to 30 micrometers, and
the cellulose nanofibers having an average fiber diameter of 1 to 200 nm.

2. The oilfield apparatus according to claim 1, wherein the seal member is an endless seal member that is disposed in the oilfield apparatus.

3. The oilfield apparatus according to claim 1, the oilfield apparatus being a logging tool that performs a logging operation in a borehole.

4. The oilfield apparatus according to claim 1, wherein the seal member is a stator of a fluid-driven motor that is disposed in the oilfield apparatus.

5. The oilfield apparatus according to claim 1, wherein the seal member is a rotor of a fluid-driven motor that is disposed in the oilfield apparatus.

6. The oilfield apparatus according to claim 4, wherein the fluid-driven motor is a mud motor.

7. The oilfield apparatus according to claim 5, wherein the fluid-driven motor is a mud motor.

8. The oilfield apparatus according to claim 1, wherein the rubber is a hydrogenated acrylonitrile-butadiene rubber (H-NBR), and the rubber composition has a volume resistivity of 10⁸ to 10¹⁰ ohm-cm.

9. The oilfield apparatus according to claim 2, wherein the rubber is a hydrogenated acrylonitrile-butadiene rubber (H-NBR), and the rubber composition has a volume resistivity of 10⁸ to 10¹⁰ ohm-cm.

10. The oilfield apparatus according to claim 3, wherein the rubber is a hydrogenated acrylonitrile-butadiene rubber (H-NBR), and the rubber composition has a volume resistivity of 10⁸ to 10¹⁰ ohm-cm.

11. The oilfield apparatus according to claim 6, wherein the rubber is a hydrogenated acrylonitrile-butadiene rubber (H-NBR), and the rubber composition has a volume resistivity of 10⁸ to 10¹⁰ ohm-cm.

12. The oilfield apparatus according to claim 7, wherein the rubber is a hydrogenated acrylonitrile-butadiene rubber (H-NBR), and the rubber composition has a volume resistivity of 10⁸ to 10¹⁰ ohm-cm.

13. The oilfield apparatus according to claim 8, wherein the rubber composition has a number of cycles to fracture of 3,000 or more when subjected to a tension fatigue test at a temperature of 120° C., a maximum tensile stress of 1 N/mm, and a frequency of 1 Hz.

14. The oilfield apparatus according to claim 9, wherein the rubber composition has a number of cycles to fracture of 3,000 or more when subjected to a tension fatigue test at a temperature of 120° C., a maximum tensile stress of 1 N/mm, and a frequency of 1 Hz.

15. The oilfield apparatus according to claim 10, wherein the rubber composition has a number of cycles to fracture of 3,000 or more when subjected to a tension fatigue test at a temperature of 120° C., a maximum tensile stress of 1 N/mm, and a frequency of 1 Hz.

16. The oilfield apparatus according to claim 11, wherein the rubber composition has a number of cycles to fracture of 3,000 or more when subjected to a tension fatigue test at a temperature of 120° C., a maximum tensile stress of 1 N/mm, and a frequency of 1 Hz.

17. The oilfield apparatus according to claim 12, wherein the rubber composition has a number of cycles to fracture of 3,000 or more when subjected to a tension fatigue test at a temperature of 120° C., a maximum tensile stress of 1 N/mm, and a frequency of 1 Hz.

18. The oilfield apparatus according to claim 8, wherein the rubber composition has an elongation at break of 330% or more.

19. The oilfield apparatus according to claim 13, wherein the rubber composition has an elongation at break of 330% or more.
